(19) United States
(12) Patent Application Publication
(10) Pub. No.: US 2026/0292180 A1
(43) Pub. Date: Sep. 24, 2026

(54) DECODING METHOD, ENCODING METHOD, AND DECODER

(71) Applicant: GUANGDONG OPPO MOBILE TELECOMMUNICATIONS CORP., LTD., Dongguan (CN)

(72) Inventors: Jonathan GAN, Dongguan (CN); Yue YU, Dongguan (CN)

(21) Appl. No.: 19/691,476

(22) Filed: May 28, 2026

Related U.S. Application Data
(63) Continuation of application No. PCT/CN2024/129793, filed on Nov. 4, 2024.
(60) Provisional application No. 63/605,022, filed on Dec. 1, 2023.
(60) Provisional application No. 63/619,281, filed on Jan. 9, 2024.
(60) Provisional application No. 63/619,594, filed on Jan. 10, 2024.

(51) Int. Cl. H04N 19/13; H04N 19/176; H04N 19/70

(52) U.S. Cl. CPC H04N 19/13; H04N 19/176; H04N 19/70

(57) ABSTRACT

A method of decoding by a decoder is provided. The method may include performing, by a processor, a context-adaptive binary arithmetic coding (CABAC) bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the method may include decoding, by the processor, syntax elements for the coefficient during its respective coding pass. The method may include calculating, by the processor, the coefficient based on the syntax element.

### CROSS-REFERENCE TO RELATED APPLICATIONS

This application is a continuation of International Application No. PCT/CN2024/129793, filed Nov. 4, 2024, which claims priority to: U.S. Provisional Application No. 63/605,022, filed Dec. 1, 2023; U.S. Provisional No. 63/619,281, filed Jan. 9, 2024; and U.S. Provisional Application No. 63/619,594, filed Jan. 10, 2024, the entire disclosures of which are incorporated herein by reference.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, enhanced video coding model (ECM), to name a few.

### SUMMARY

According to one aspect of the present disclosure, a method of decoding by a decoder is provided. The method may include performing, by a processor, a context-adaptive binary arithmetic coding (CABAC) bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the method may include decoding, by the processor, syntax elements for the coefficient during its respective coding pass. The method may include calculating, by the processor, the coefficient based on the syntax elements.

According to another aspect of the present disclosure, a decoder is provided. The decoder may include a processor and memory storing instructions. The memory storing instructions, which when executed by the processor, may cause the processor to perform a CABAC bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the memory storing instructions, which when executed by the processor, may cause the processor to decode syntax elements for the coefficient during its respective coding pass. The memory storing instructions, which when executed by the processor, may cause the processor to calculate the coefficient based on the syntax elements.

According to yet another aspect of the present disclosure, a method of encoding by An encoder is provided. The method may include calculating, by a processor, a coefficient in a residual subblock. The method may include performing, by a processor, a CABAC bin-budget check for X CABAC bins at a start of a respective coding pass for each coefficient in the residual subblock. There may be X possible syntax elements for each coefficient. In response to the CABAC bin-budget check indicating at least X CABAC bins are available at the start of a respective coding pass for a coefficient, the method may include encoding, by the processor, syntax elements for the coefficient during its respective coding pass.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7 illustrates a diagram of a first RRC scan order, according to some embodiments of the present disclosure.

FIG. 8 illustrates a diagram of a second RRC scan order, according to some embodiments of the present disclosure.

FIG. 9 illustrates a diagram of a TSRC scan order, according to some embodiments of the present disclosure.

FIG. 10 illustrates a flowchart of a first method of video coding, according to some embodiments of the present disclosure.

FIG. 11 illustrates a flowchart of a second method of video coding, according to some embodiments of the present disclosure.

FIG. 12 illustrates a flowchart of a third method of video coding, according to some embodiments of the present disclosure.

FIG. 13 illustrates a flowchart of a fourth method of video coding, according to some embodiments of the present disclosure.

FIG. 14 illustrates a flowchart of a fifth method of video coding, according to some embodiments of the present disclosure.

FIG. 15 illustrates a flowchart of a first method of decoding, according to some embodiments of the present disclosure.

FIG. 16 illustrates a flowchart of a second method of decoding, according to some embodiments of the present disclosure.

FIG. 17 illustrates a flowchart of a first method of encoding, according to some embodiments of the present disclosure.

FIG. 18 illustrates a flowchart of a second method of encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

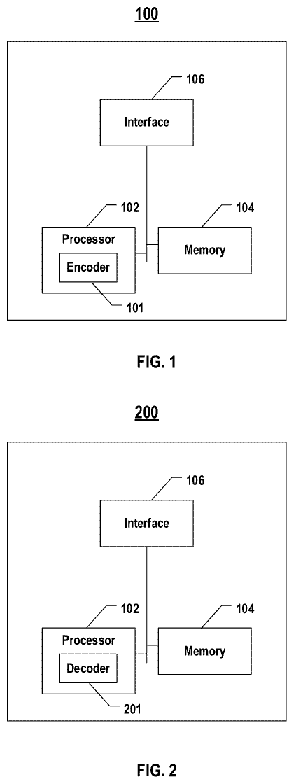

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

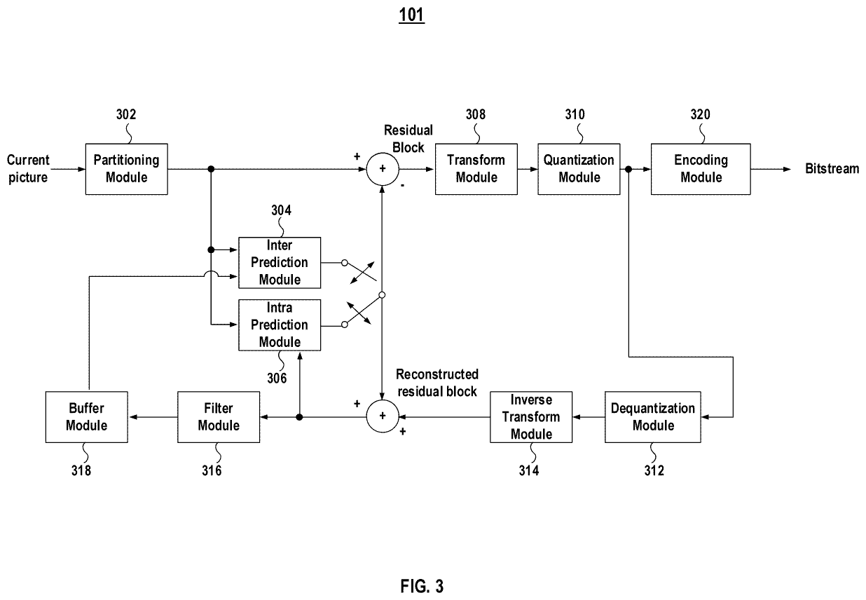

FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 302 may partition a picture into a combination of a plurality of coding units, prediction units, and transform units, and encode a picture by selecting a combination of a coding unit, a prediction unit, and a transform unit based on a predetermined criterion (e.g., a cost function).

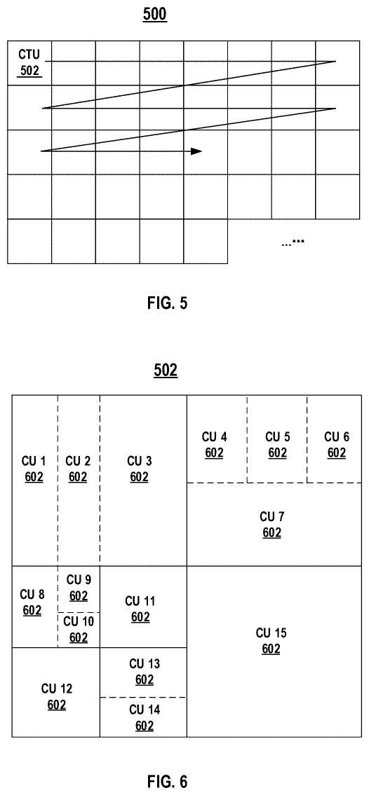

Similar to H.265/HEVC, H.266/VVC is a block-based hybrid spatial and temporal predictive coding scheme. As shown in FIG. 5, during encoding, an input picture 500 is first divided into square blocks referred to as coding tree units (CTUs)—CTUs 502, by partitioning module 302. For example, CTUs 502 can be blocks of 128×128 pixels. As shown in FIG. 6, each CTU 502 in input picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU or be subdivisions of root CTU 502 as small as 4×4 blocks, according to some embodiments.

Referring to FIG. 3, inter prediction module 304 may be configured to perform inter prediction on a prediction unit, and intra prediction module 306 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a coding unit, and prediction may be performed in a prediction unit. Residual coefficients in a residual block between the generated prediction block and the original block may be input into transform module 308. In addition, prediction mode information, motion vector information, and the like used for prediction may be encoded by encoding module 320 together with the residual coefficients or quantization levels into the bitstream. It is understood that in certain encoding modes, an original block may be encoded as it is without generating a prediction block through prediction module 304 or 306. It is also understood that in certain encoding modes, prediction, transform, and/or quantization may be skipped as well.

In some embodiments, inter prediction module 304 may predict a prediction unit based on information on at least one picture among pictures before or after the current picture, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. Intra prediction may be performed on the prediction unit based on previously decoded pixels neighbouring the prediction unit on the left, above-left, and above.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual block including a prediction unit that has performed prediction based on the prediction unit generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying an M×M DCT to each row, resulting in intermediate transform coefficients, and then applying an N×N DCT to each column of intermediate transform coefficients.

For intra-coded CUs (also referred to herein as “intra CUs”), spatial neighboring reconstructed samples are used to predict the current block, and the intra prediction mode is signaled once for the entire CU. Each CU consists of one or more collocated coding blocks (CBs) corresponding to the color components of the video sequence. For example, consumer video typically takes the 4:2:0 chroma format, in which case each CU consists of a luma CB and two chroma CBs with one-quarter of the samples of the luma CB. Intra prediction and transform coding are performed at the prediction block (PB) and transform block (TB) levels, respectively. Each CB consists of a single TB, except in the cases of Intra Subpartition (ISP) mode and implicit splitting. For luma CBs, the maximum side length of a TB is 64, and the minimum side length is 4. In addition, luma TBs are further specified as W x H rectangular blocks of width W and height H, where W, HE {4, 8, 16, 32, 64}. For chroma CBs, the maximum TB side length is 32, and chroma TBs are rectangular W×H blocks of width W and height H. Here, W, H E {2, 4, 8, 16, 32}, but blocks of shapes 2×H and 4×2 are excluded in order to address memory architecture and throughput requirements.

To determine whether samples have already been reconstructed, we consider the partitioning structure of VVC. Referring to FIG. 5, each picture is divided into a tiling of square CTUs, which are processed in raster scan order. When an intra prediction method is performed on a current CU 602 in a current CTU 502, samples belonging to other CTUs preceding current CTU 502 in raster scan order are reconstructed and may be available for prediction. Samples belonging to CTUs following the current CTU 502 in raster scan order are not reconstructed and, therefore, are not available.

Each CTU 502 itself is partitioned into CUs by a hierarchical structure consisting of quadtree, binary tree, and ternary tree splits, with an example of such splits shown in FIG. 6. The scan order of CUs within a CTU 502 is determined by the partitioning structure. For a single level of partitioning split, the partitions are scanned in the following order: 1) left to right for the cases of horizontal binary tree split or horizontal ternary tree split, 2) top to bottom for the cases of vertical binary tree split or vertical ternary tree split, and 3) top-left, top-right, bottom-left, bottom-right for the case of quadtree split.

If a partition contains further hierarchical splits, then all CUs within that partition are scanned before continuing to the CUs in the next partition. FIG. 6 shows an example of partitioning of a CTU 502 into 15 CUs. Each CU 602 in FIG. 6 is numbered from 1 to 15 to indicate their scan order. When an intra prediction method is performed on a current CU in a current CTU, samples belonging to other CUs in the current CTU that precede the current CU in the current CTU's partitioning scan order are reconstructed and may be available for prediction. Samples belonging to the current CU, or CUs following the current CU in the current CTU's partitioning scan order are not reconstructed and, therefore, not available.

Samples belonging to a CTU preceding the current CTU in raster scan order are considered reconstructed by the definition above. However, they are not necessarily available for intra prediction. To be considered available for prediction, they must also belong to a logical unit that the current CU is permitted to use. Pictures may be divided into sub-picture partitions, each of which contains a whole number of CTUs.

Referring again to FIG. 3, transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses a fixed probability of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 318 may be configured to store the reconstructed block or picture calculated through filter module 316, and the reconstructed and stored block or picture may be provided to inter prediction module 304 when inter prediction is performed.

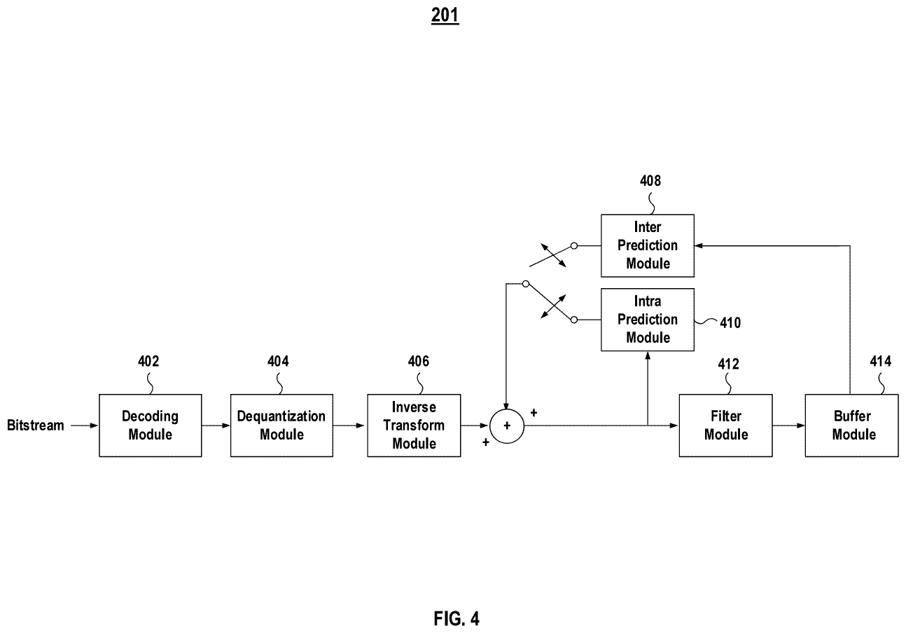

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure opposite to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse discrete cosine transform (DCT), inverse discrete sine transform (DST), and inverse Karhunen-Loève transform (KLT), for DCT, DST, and KLT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT) according to a plurality of pieces of information such as a prediction method, a size of the current block, a prediction direction, and the like.

Inter prediction module 408 and intra prediction module 410 may be configured to generate a prediction block based on information related to the generation of a prediction block provided by decoding module 402 and information of a previously decoded block or picture provided by buffer module 414. Intra prediction may be performed on the prediction unit based on previously decoded pixels neighbouring the prediction unit on the left, above-left, and above.

Video data is highly compressible because it is highly redundant in both the spatial and temporal dimensions. Theoretically, such redundancy can be compressed solely with an entropy coder (located at encoding module 320 and decoding module 402) modeling the statistical characteristics of the video data at a high enough order. However, the dimensionality of such a statistical model would be infeasibly high, making such an approach impractical to implement. For this reason, modern video coding standards typically use a block-based hybrid predictive paradigm, in which much of the redundancy of the video signal is exploited by block-based prediction. As used herein, the term “coding” refers to encoding or decoding.

In VVC, the prediction methods used are selected at a CU level, with one method selected for predicting the luma component and another method selected for predicting the chroma components. Each color component of a CU is referred to as a coding block (CB). In some cases, e.g., such as the intra sub-partition (ISP) tool, the CB may be further subdivided into multiple prediction blocks (PB), with a prediction generated for each PB. However, in most cases, the CB corresponds to a single PB of the same size. The difference between the original samples of the PB and the prediction is referred to as the residual, and ideally, the residual is minimized when the prediction is accurate.

For video data typically captured using a camera, the residual may benefit from applying a transform, e.g., such as a two-dimensional discrete cosine transform (DCT), before quantizing, and then the transform coefficients are coded. As with prediction methods, the choice of transform can be selected on a block-by-block basis, including selection of a “transform skip” mode. Each PB typically corresponds to a single transform block (TB) of the same size, which means that the transform (or transform skip) is applied directly to the residual of the PB. However, in some cases, a PB may be further subdivided into multiple TBs. For example, if the size of the PB is larger than the largest transform supported by the decoding module 402, then the PB may be divided into tiled TBs of size that can be transformed. For example, a 256×256 size PB would be divided into 4 TBs of 128×128 size when the decoding module 402 can only support up to 128-point DCT transforms.

Residual coding then refers to the process of coding the residual samples in each transform block (also referred to as a “residual block”) to the bitstream. In VVC, there are two alternative processes. For blocks where a transform is selected, the resulting transform coefficients are binarized and coded through a regular residual coding (RRC) process, which is performed by the encoding module 320 and the decoding module 402. For blocks where transform skip is selected, the residual coefficients may be coded by a process called the transform skip residual coding (TSRC) process, which is performed by the encoding module 320 and the decoding module 402. This latter process may be overridden (e.g., the RRC is forced even for transform skip blocks) if a slice-level TSRC disable flag is set.

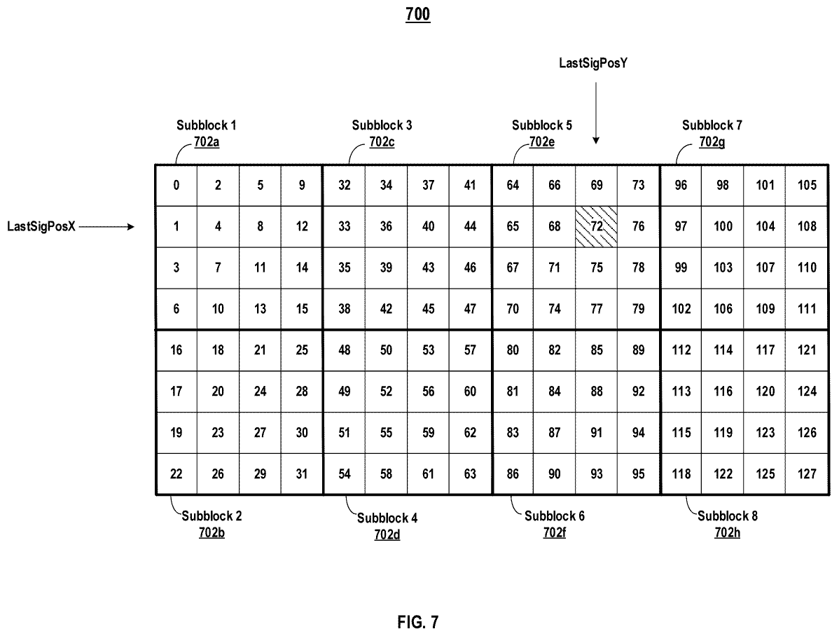

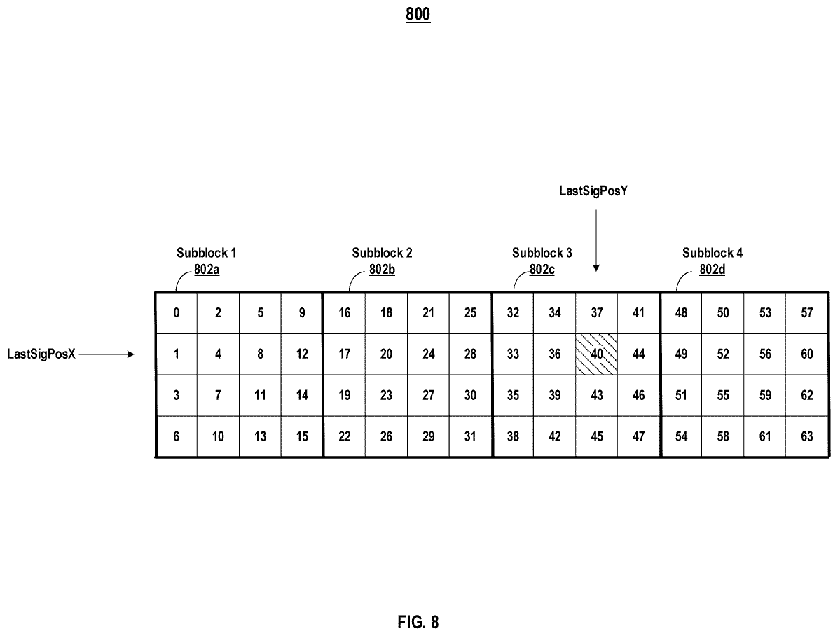

In RRC, the coding process is highly optimised for the purpose of coding transform coefficients. One purpose of applying a transform is to produce energy compaction—that is, the energy of the original residual is compacted into a relatively small number of transform coefficients. This implies that after quantisation, many transform coefficients should be zero in value. To efficiently code this, VVC employs a hierarchical subblock coding scheme. Transform coefficients are grouped into 4×4 subblocks (as shown in FIGS. 7 and 8), and for each subblock a subblock coded flag (sb_coded_flag) may be signaled or inferred. A subblock coded flag value of 1 indicates that at least one coefficient in the subblock is non-zero, while a value of 0 indicates that all the coefficients are zero.

As a transform should result in energy compaction, a natural question may be compaction in which coefficients. The application of a transform in VVC typically results in large-valued transform coefficients occurring in a localised (top-left) area of the block. For example, when the DCT is used, the transform coefficients correspond to spatial frequencies of the residual signal. By convention, the coefficients are ordered from low frequency to high frequency, with horizontal frequencies ordering left to right and vertical frequencies ordering top to bottom. That is, the low frequency coefficients both horizontally and vertically are located at the top-left of the block, while the high frequency coefficients both horizontally and vertically are located at the bottom-right of the block. It is known that “natural” (e.g., camera-captured) images have most of their energy concentrated in the low frequencies, and therefore, the coefficients corresponding to these frequencies, which reside in the top-left of the block while have the largest values. Other transforms used in VVC either are similar in behaviour due to also being frequency-based transforms such as the multi transform set (MTS), or are designed to concentrate large-valued coefficients in the same top-left area.

RRC exploits this localised property of transform coefficients in two ways. Firstly, a hierarchical reverse diagonal scan through the coefficients is defined, which begins at the highest spatial frequencies (the bottom-right of the block), and ends at the lowest spatial frequencies (the top-left of the block). This scan order approximately orders the coefficients from low to high magnitude. Entropy coding is performed along the direction of this scan order, which allows efficient adaptation to the changing statistics of the coefficients as they increase in magnitude gradually. Secondly, as it is expected many of the high frequency coefficients are quantized to zero, the position of the last significant coefficient (in the forward direction of the hierarchical diagonal scan) is signaled.

FIG. 7 illustrates a diagram of a first RRC scan order 700 for a 16×8 residual block, according to some embodiments of the present disclosure. The coefficient positions are each labeled with their order in the forward direction of the hierarchical diagonal scan, so that the top-left most position is labelled 0, and so on. The scan is hierarchical because whenever it enters a subblock (e.g., subblock 1 702a, subblock 2 702b, subblock 3 702c, subblock 4 702d, subblock 5 702e, subblock 6 702f, subblock 7 702g, or subblock 8 702h) it passes through all coefficients of that subblock before continuing to the next subblock. In this non-limiting example, the last significant position is identified at position 72 by signaling the horizontal component of the last significant position (LastSigPosX=10) and the vertical component of the last significant position (LastSigPosY=1). Then, the hierarchical reverse diagonal scan for this example begins at position 72, and proceeds backward through the numbered positions 71, 70, and so forth, ending at position 0.

FIG. 8 illustrates a diagram of a second RRC scan order 800 for a 16×4 residual block, according to some embodiments of the present disclosure. In this non-limiting example, the last significant position is in the same spatial location as in FIG. 7, e.g., that is, at LastSigPosX=10 and LastSigPosY=1. However, its position in the scan order is different because of the arrangement of the subblocks (e.g., subblock 1 802a, subblock 2 802b, subblock 3 802c, and subblock 4 802d). The hierarchical reverse diagonal scan for this example begins at position 40, and proceeds backward through the numbered positions 39, 38, and so forth, ending at position 0.

After the last significant position is signaled, the RRC proceeds with coding the coefficients subblock by subblock in the reverse diagonal scan order. At the start of each subblock, a subblock coded flag (sb_coded_flag) is signaled before any syntax elements for the coefficients themselves within that subblock. A subblock coded flag with value 0 indicates that all the coefficients within that subblock have the value zero, and so do not need to be signaled. Conversely, a subblock coded flag with value 1 indicates that there may be coefficients with non-zero values, so some further signaling is performed.

Because all coefficients after the last significant position must be zero valued, subblock coded flags for subblocks after the last significant position are not signaled. Their values, and the values of the transform coefficients contained in them, can be inferred as zero. The subblock containing the last significant position is guaranteed to contain at least one significant coefficient, so its subblock coded flag also does not need to be signaled and is automatically inferred to have a value of 1. The top-left subblock (e.g., subblock 1 702a in FIG. 7 and subblock 1 802a in FIG. 8 containing coefficient positions 0-15) is not guaranteed to contain significant coefficients but is highly likely to because it has the lowest frequency coefficients which are most likely to have large magnitude. The top-left subblock is also often referred to as the “DC subblock”. Then, by design the subblock coded flag corresponding to the DC subblock is also inferred to have a value of 1. All other subblock coded flags are signaled.

In the non-limiting example of FIG. 7, the subblock coded flags for the subblocks containing coefficient positions 80-95 (subblock 6 702f), 96-111 (subblock 7 702g) and 112-127 (subblock 8 702h) inclusive are inferred as zero because they are following the last significant position. The subblock coded flag for the subblock containing coefficient positions 64-79 (subblock 5 702e) is inferred as one because it contains the last significant position. Following this inference, the coefficients at positions 64-79 are signalled, starting at the last significant position 72 and progressing backward in the reverse scan order. Next, the subblock coded flag for the subblock containing coefficient positions 48-63 (subblock 4 702d) is signaled. If the subblock coded flag has the value 1, then the corresponding coefficients at positions 48-63 are signaled next. This is repeated for the subblocks containing coefficient positions 32-47 (subblock 3 702c) and 16-31 (subblock 2 702b) in that order (e.g., following the reverse scan order). Finally, the subblock coded flag for the subblock containing coefficient positions 0-15 is inferred as one, and the coefficients at positions 0-15 are signaled.

VVC utilises a context adaptive binary arithmetic coder (CABAC) (located in encoding module 320 and decoding module 402), which can adapt to and efficiently code a variety of syntax elements with different statistical properties. However, CABAC is computationally intensive compared to alternatives such as variable length binarization. For this reason, CABAC is not exclusively used to code syntax elements in VVC. In particular, the coding of residual coefficients occupies a significant portion of the total video bitstream. To ensure real-time encoders and decoders can maintain the throughput of CABAC coding, the extent of CABAC coding is limited for the heaviest burden on CABAC, which is coefficient coding. When encoding, transform coefficients are firstly binarized in a process described in detail below, with the individual bits after binarization referred to as “bins.” Each bin can then be coded either by the CABAC engine, in which case it is referred to as a “context coded bin,” or passed through to the bitstream as a bit, in which case it is referred to as a “bypass coded bin.” The maximum number of bins that are permitted to be context coded bins is referred to as the “CABAC bin budget” or “context coded bin budget” and is set at the residual block level to 1.75 bins per coefficient. For example, the 16×8 residual block of FIG. 7 has a CABAC bin budget of 1.75×16×8=224 bins. This limit applies only to syntax elements related to coefficient coding, which are described further below, and not to any other higher level syntax elements. The last significant position syntax elements and the subblock coded flags are not counted by the CABAC bin budget.

Each transform coefficient can be coded by a mixture of context and bypass coding, depending on the state of the CABAC bin budget and the magnitude of the coefficient itself. This is handled by several coding passes through the subblock, with each pass proceeding through the coefficients of the subblock in the reverse scan order already described above. That is, each coding pass begins at the last coefficient position and progresses backward through the numbered coefficient positions until terminated by some condition, or ending at the top-left most coefficient position in the subblock. For the subblock containing the last significant position, the last coefficient position is the last significant position, while for all other subblocks the last coefficient position is the bottom-right most coefficient position. The first two coding passes code the magnitude of the coefficients, while the third and final coding pass codes the sign of the coefficients.

The first coding pass binarizes and codes context coded syntax elements, and proceeds until either the CABAC bin budget is exhausted, or the pass reaches the end of the scan order. At each coefficient position, we first check whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements as described below. In the case where the first coding pass ends without terminating early (e.g., exhausting the CABAC bin budget) n is set to the value of the top-left coefficient position of the subblock minus one.

What context coded syntax elements are coded in the first coding pass depends at each coefficient on the magnitude of the coefficient. Firstly, a “significant coefficient flag” (sig_coeff_flag) may be signaled or inferred. This flag has a value of 0 when a current coefficient is zero in magnitude, and a value of 1 when the current coefficient is non-zero. Note that when a subblock coded flag has a value of 0, no further syntax elements are signaled for that subblock, and all sig_coeff_flag syntax elements corresponding to that subblock are inferred as 0. The sig_coeff_flag may be inferred as 1 for other edge cases. For example, at the last significant position the coefficient is already known to be significant and does not need to be signaled. Additionally, if a subblock coded flag has been signaled with a value of 1 but all significant coefficient flags within that subblock have a value of 0 until the final (e.g., the top-left most) significant coefficient flag for that subblock, that final significant coefficient flag must be inferred as 1. In all other cases, the significant coefficient flag is signalled.

If the significant coefficient flag is 0, then the coding pass proceeds to the next coefficient, as the current coefficient's value is already fully determined as zero. However, if the significant coefficient flag is 1, then next, a “greater than one flag” (gt1_flag) is signaled. This flag has a value of 1 when the current coefficient's magnitude is greater than one, and a value of 0 when the current coefficient's magnitude is one or less. If the greater than one flag is 0, then the coding pass proceeds to the next coefficient, as the current coefficient's magnitude is fully determined as one. If the greater than one flag is 1, then two more flags are signaled—a “parity flag”, and a “greater than three flag” (gt3_flag).

The parity flag has a value of 1 when the current coefficient's magnitude is odd, and has a value of 0 when the current coefficient's magnitude is even. The greater than three flag has a value of 1 when the current coefficient's magnitude is greater than three, and a value of 0 when the current coefficient's magnitude is three or less.

With each flag that is signaled, the remaining CABAC bin budget is decremented by one bin. Note that the remaining CABAC bin budget continues to be tracked and carries across the subblocks of the residual block. The number of context coded bins consumed by each coefficient is equal to the number of flags signaled, which depends on the coefficient's magnitude. However, the worst case is four bins, which is why the check at the beginning of each coefficient requires at least 4 bins in the remaining CABAC bin budget.

The second coding pass binarizes and codes with bypass coded bins the remaining portion of the transform coefficient magnitudes that have not already been coded in the first coding pass. The second coding pass is split into two parts. The first part is a pass over the coefficients from the last coefficient position of the subblock until before (not including) coefficient position n. The second part is a pass over the coefficients from position n to the top-left coefficient position in the subblock. The second coding pass can consist of just one of the parts. For example, if the first coding pass is completed without exhausting the CABAC bin budget, then the second coding pass will consist only of the first part. If the CABAC bin budget was already exhausted before the first coding pass began, then the second coding pass will consist only of the second part.

For each coefficient in the first part of the second coding pass, some part of the current coefficient's magnitude has already been signaled by the first coding pass. Therefore, in this case, a remainder may be signaled (abs_rem). No remainder needs to be signaled if the coefficient's magnitude can be fully determined from the context coded flags already signaled. As shown in Table 1, a remainder needs to be signaled when the greater than three flag has been signaled with a value of 1. Because the parity flag has already been signaled, the remaining part is always even in value. Therefore, abs_rem is signaled as a non-negative integer quantity, but then multiplied by two when added to reconstruct the coefficient's magnitude. abs_rem is binarized with a truncated Rice-Golomb binarization and bypass coded.

TABLE 1
Mapping between RRC coefficient syntax elements
and coefficient magnitude

| sig_coeff_flag | gt1_flag | parity_flag | gt3_flag | Coefficient magnitude |
|---|---|---|---|---|
| 0 | — | — | — | 0 |
| 1 | 0 | — | — | 1 |
| 1 | 1 | 0 | 0 | 2 |
| 1 | 1 | 1 | 0 | 3 |
| 1 | 1 | 0 | 1 | 4 + 2*abs_rem |
| 1 | 1 | 1 | 1 | 5 + 2*abs_rem |
| — | — | — | — | dec_abs_level |

For each coefficient in the second part of the second coding pass, the first coding pass had already terminated, so all the current coefficient's magnitude (dec_abs_level) must be determined. dec_abs_level is not signaled and inferred as 0 for coefficients belonging to subblocks with a subblock coded flag of 0. Otherwise, it is binarized with a truncated Rice-Golomb binarization and bypass coded.

The third coding pass codes the sign bits associated with the transform coefficients. One sign bit is signaled for each non-zero transform coefficient—that is, for each coefficient with a significant coefficient flag with value 1. All the sign bits are bypass coded.

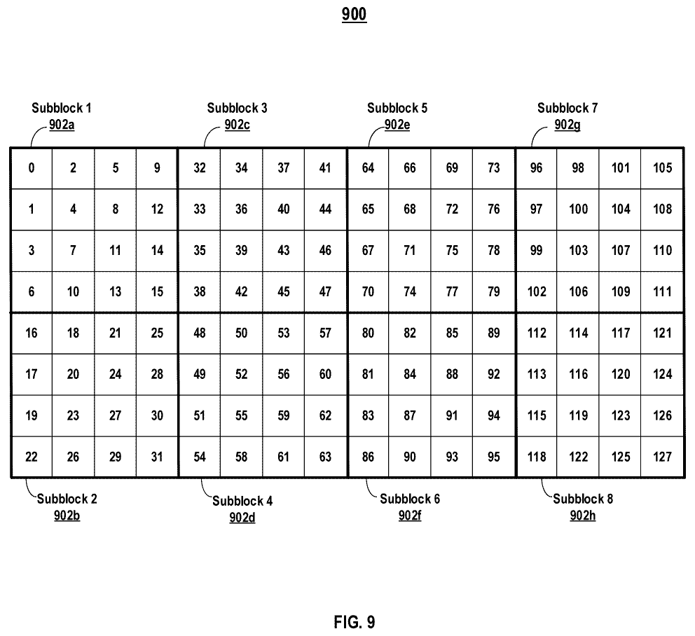

FIG. 9 illustrates a diagram of a TSRC scan order 900 with a 16×8 residual block, according to some embodiments of the present disclosure. The TSRC process is optimised for coding residual blocks that do have any transform applied. There are significant differences in the properties of the residual block, as compared to the residual block of RRC. Firstly, because there is no transform applied, there is no reason to expect the energy of the residual signal to be concentrated in the top-left coefficients, or for many coefficients in the bottom-right of the residual block to be quantised to zero. For this reason, the last significant position is not signaled in TSRC. Moreover, at least for intra predicted blocks, the prediction is made using neighbouring samples on the top-left edge of the coding block. On average, the top-left of the coding block may be predicted more accurately, resulting in smaller residual samples in the top-left of the block.

In TSRC, the residual coefficients are scanned with a hierarchical forward diagonal scan, which begins at the top-left of the block and ends at the bottom-right of the block. In the non-limiting example of FIG. 9, the hierarchical forward diagonal scan begins at position 0, then proceeds forwards through the numbered positions 1, 2, and so forth, ending at position 127.

Similar to RRC, for each 4×4 group of residual coefficients a subblock coding flag is determined. Unlike RRC, the subblock coding flag for the “DC subblock” is not inferred as 1. The last subblock coded flag (e.g., corresponding to subblock 8 902h) is inferred as 1 if all other subblock coded flags before the last subblock (e.g., subblock 8 902h) have a value of 0. Otherwise, the last subblock coded flag is also signaled.

In the example shown in FIG. 9, the subblock coded flag for the subblock containing coefficient positions 0-15 (subblock 1 902a) is signalled first. If the subblock coded flag has the value 1, then the corresponding coefficients at positions 0-15 are signalled. This is repeated for the subblocks containing coefficient positions 16-31 (subblock 2 902b), 32-47 (subblock 3 902c), 48-63 (subblock 4 902d), 64-79 (subblock 5 902e), 80-95 (subblock 6 902f), and 96-111 (subblock 7 902g) in that order (e.g., following the forward scan order). Finally, the subblock coded flag for the subblock containing coefficient positions 112-127 (subblock 8 902h) may be inferred as one if all other subblock coded flags have a value of 0, and is signalled otherwise. If the subblock coded flag has the value 1, the coefficients at positions 112-127 are signalled.

Like RRC, the TSRC process also codes the residual coefficients with a mixture of context and bypass coding. The amount of context coding allowed is controlled by the CABAC bin budget, which is calculated at the residual block level by the same method as for RRC. TSRC also sets the CABAC bin budget to 1.75 bins per coefficient. The coefficients are visited by several coding passes, with each pass proceeding through the coefficients of the subblock in the hierarchical forward scan order already described for TSRC. That is, each coding pass begins at the top-left most coefficient position in the subblock and progresses forwards through the numbered coefficient positions until terminated by some conditions, or ending at the bottom-right most coefficient position in the subblock. The first two coding passes code syntax elements using context coding, while the third and final coding pass uses bypass coding.

The first coding pass binarizes and codes context syntax elements, and proceeds until either the CABAC bin budget is exhausted, or the pass reaches the end of the scan order. At each coefficient position, we first check whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements as described below. In the case where the first coding pass ends without terminating early (e.g., exhausting the CABAC bin budget) n is set to N, where N is the value of the bottom-right coefficient position of the subblock plus one.

What context coded bins are coded in the first coding pass depends at each coefficient on the magnitude of the coefficient. Firstly, a “significant coefficient flag” (sig_coeff_flag) may be signaled. This flag has a value of 0 when a current coefficient is zero in magnitude, and a value of 1 when the current coefficient is non-zero. Note that when a subblock coded flag has a value of 0, no further syntax elements are signalled for that subblock, and all sig_coeff_flag syntax elements corresponding to that subblock are inferred as 0. The sig_coeff_flag may be inferred as 1 for other edge cases. For example, if a subblock coded flag has been set to 1 but all significant coefficient flags within that subblock have a value of 0 until the final (e.g., bottom-right most) significant coefficient flag for that subblock, that final significant coefficient flag must be inferred as 1. In all other cases, the significant coefficient flag is signalled.

If the significant coefficient flag is 0, then the coding pass proceeds to the next coefficient, as the current coefficient's value is already fully determined as zero. However, if the significant coefficient flag is 1, then two more flags are signaled-a “sign flag” (coeff_sign_flag) and a “greater than one flag” (gt1_flag). The sign flag indicates the sign of the coefficient. For instance, it has a value of 0 when the coefficient is positive, and a value of 1 when the coefficient is negative. The greater than one flag has a value of 1 when the current coefficient's magnitude is greater than one, and a value of 0 when the current coefficient's magnitude is one or less. If the greater than one flag is 0, then the coding pass proceeds to the next coefficient, as the current coefficient's magnitude is fully determined as one. If the greater than one flag is 1, then a parity flag is finally signaled, and the coding pass proceeds to the next coefficient. The parity flag has a value of 1 when the current coefficient's magnitude is odd, and has a value of 0 when the current coefficient's magnitude is even.

With each flag that is signaled, the remaining CABAC bin budget is decremented by one bin. Note that the remaining CABAC bin budget continues to be tracked and carries across the subblocks of the residual block. The number of context coded bins consumed by each coefficient is equal to the number of flags signaled, which depends on the coefficient's magnitude. However, the worst case is four bins, which is why the check at the beginning of each coefficient requires at least 4 bins in the remaining CABAC bin budget.

The second coding pass further codes the magnitude of the residual coefficients with context coded bins. As with the first coding pass, at each coefficient position, it is first checked whether the remaining CABAC bin budget is at least 4 bins. If it is less than 4 bins, then the second coding pass ends and the coefficient position where it has ended is recorded to a variable m. If the remaining CABAC bin budget is at least 4 bins, then the second coding pass can proceed by coding the coefficient at that position with syntax elements as described below. In the case where the first coding pass ends without terminating early (e.g., exhausting the CABAC bin budget) m is set to N.

What context coded bins are coded in the second coding pass depends on each coefficient on the magnitude of the coefficient. Firstly, if either the significant coefficient flag or the greater than one flag for the current coefficient were signaled as 0 in the first coding pass, then the current coefficient's magnitude is already fully determined, and no further syntax elements need to be signaled. Then, the coding pass proceeds to the next coefficient. Otherwise, up to four “greater than X” flags may be signaled, being “greater than three flag” (gt3_flag), “greater than five flag” (gt5_flag), “greater than seven flag” (gt7_flag), and “greater than nine flag” (gt9_flag) in signaling order. The gt3_flag is signaled first, and each subsequent greater than X flag is signaled if the prior greater than X flag has a value of 1. When any greater than X flag is signaled with a value of 0, or if the greater than nine flag is signaled, the coding pass proceeds to the next coefficient.

The third coding pass binarizes and codes with bypass coded bins the remaining portion of the residual coefficients that have not already been coded in the first two coding passes. The third coding pass is split into three parts. The first part is a pass over the coefficients from the first (top-left) coefficient until before (not including) coefficient position m. The second part is a pass over the coefficients from position m until before coefficient position n. The third part is a pass over the coefficients from position n to the last (bottom-right) coefficient position. Not all the parts occur in the third coding pass. For example, if the first two coding passes are completed without exhausting the CABAC bin budget, then m=n=N and the third coding pass will consist only of the first part. If the CABAC bin budget was exhausted in the second coding pass, then n=N and the third part of the third coding pass does not occur. If the CABAC bin budget was exhausted in the first coding pass, it will also be exhausted before the second coding pass can begin, so m will be the top-left most coefficient position, and the first part of the third coding pass does not occur.

A remainder is signaled when the current coefficient's value has not already been determined by signaled flags. As shown in Table 2, the coefficient can be fully determined if the sig_coeff_flag or any one of the greater than X flags has been signaled with a value of 0.

TABLE 2
Mapping between TSRC coefficient syntax elements and coefficient magnitude

| sig_coeff_flag | gt1_flag | gt3_flag | gt5_flag | gt7_flag | gt9_flag | Coefficient magnitude |
|---|---|---|---|---|---|---|
| 0 | — | — | — | — | — | 0 |
| 1 | 0 | — | — | — | — | 1 |
| 1 | 1 | — | — | — | — | 2 + parity flag + |
| | | | | | | 2*abs_rem |
| 1 | 1 | 0 | — | — | — | 2 + parity_flag |
| 1 | 1 | 1 | 0 | — | — | 4 + parity_flag |
| 1 | 1 | 1 | 1 | 0 | — | 6 + parity_flag |
| 1 | 1 | 1 | 1 | 1 | 0 | 8 + parity_flag |
| 1 | 1 | 1 | 1 | 1 | 1 | 10 + parity_flag + |
| | | | | | | 2*abs_rem |
| — | — | — | — | — | — | abs_rem |

For each coefficient in the first part of the third coding pass, some part of the current coefficient's magnitude has been signaled by both the first and second coding passes. In this case a remainder (abs_rem) is signaled when the “greater than nine” flag (gt9_flag) has been signaled with a value of 1. Because the parity flag has already been signaled, the remaining part is always even in value. Therefore, abs_rem is signaled as a non-negative integer quantity, but then multiplied by two when added to reconstruct the coefficient's magnitude. The magnitude is determined as 10+parity_flag+2*abs_rem. abs_rem is binarized with a truncated Rice-Golomb binarization and bypass coded.

For each coefficient in the second part of the third coding pass, some part of the current coefficient's magnitude has been signaled by the first coding pass, but not by the second coding pass. In this case abs_rem is signaled when the greater than one flag has been signaled with a value of 1. Therefore, abs_rem is signaled as a non-negative integer quantity, but then multiplied by two when added to reconstruct the coefficient's magnitude. The magnitude is determined as 2+parity flag+2*abs_rem. abs_rem is binarized with a truncated Rice-Golomb binarization and bypass coded.

For each coefficient in the third part of the third coding pass, the first coding pass had already terminated, so all the current coefficient's value must be determined. abs_rem is not signaled and inferred as 0 for coefficients belonging to subblocks with a subblock coded flag of 0. Otherwise, it is binarized with a truncated Rice-Golomb binarization and bypass coded. If abs_rem is signaled, then the sign bit is signaled afterward as a bypass coded bin.

An RRC process has been proposed for ECM to replace the RRC process used in VVC. In the ECM RRC proposal, the syntax elements used to signal the transform coefficient magnitudes are modified. Higher level aspects of the RRC (e.g., the scan order, subblock coded flag signaling, last significant position signaling) have not been modified. Firstly, the number of greater than X flags is increased to F, where F=7. Secondly, the parity flag is moved in signaling order to after all the greater than X flags, and the parity flag is bypass coded. Because the parity is not known when the greater than X flags are signaled, the greater than X flags must increment by 1 at a time, rather than 2 at a time as in the RRC process of VVC.

In total, the context coded flags used to signal the transform coefficient magnitude are: significant coefficient flag, (sig_coeff_flag), greater than one flag (gt1_flag), greater than two flag, (gt2_flag), greater than three flag (gt3_flag), greater than four flag (gt4_flag), greater than five flag (gt5_flag), greater than six flag (gt6_flag), and greater than seven flag (gt7_flag).

At each coefficient position in the first coding pass, the new RRC still checks whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements corresponding to the first coding pass, such as significant coefficient flag, greater than X flags, and parity flag. In the case where the first coding pass ends without terminating early (e.g., exhausting the CABAC bin budget) n is set to the value of the top-left coefficient position minus one.

The significant coefficient flag may be signaled or inferred. This flag has a value of 0 when a current coefficient is zero in magnitude, and a value of 1 when the current coefficient is non-zero. When a subblock coded flag has a value of 0, no further syntax elements are signalled for that subblock, and all sig_coeff_flag syntax elements corresponding to that subblock are inferred as 0. The sig_coeff_flag may be inferred as 1 for other edge cases. For example, if a subblock coded flag has been signaled with a value of 1 but all significant coefficient flags within that subblock have a value of 0 until the final (e.g., the top-left most) significant coefficient flag for that subblock, that final significant coefficient flag must be inferred as 1. In all other cases the significant coefficient flag is signalled.

If the significant coefficient flag is 0, then the coding pass proceeds to the next coefficient, as the current coefficient's value is already fully determined as zero. Otherwise, up to seven “greater than X” flags may be signaled. The “greater than X” flags may include, e.g., “greater than one flag” (gt1_flag), “greater than two flag” (gt2_flag), “greater than three flag” (gt3_flag), “greater than four flag” (gt4_flag), “greater than five flag” (gt5_flag), “greater than six flag” (gt6_flag), and “greater than seven flag” (gt7_flag) in signalling order. The gt1 flag is signalled first, and each subsequent greater than X flag is signalled if the prior greater than X flag has a value of 1. When any greater than X flag is signalled with a value of 0, the coding pass proceeds to the next coefficient. Otherwise, if the greater than seven flag is signalled with a value of 1 (which means all the flags sig_coeff_flag, gt1_flag, . . . gt7_flag have the value 1), the parity flag is signalled as a bypass coded bin, and the coding pass proceeds to the next coefficient.

Each context coded flag that is signalled decrements the remaining CABAC bin budget by one bin. The number of context coded bins consumed by each coefficient is equal to the number of context coded flags signalled, which depends on the coefficient's magnitude. For the case F=7 and with the parity flag being bypass coded, the worst case is eight context coded bins, which means that the remaining CABAC bin budget could potentially reach a negative value (with the lowest value of −4).

Any remaining magnitude after coding the greater than X flags and the parity flag is still signaled with the bypass coded abs_rem syntax element, which is binarized with a truncated Rice-Golomb binarization and signaled in the second coding pass. If the CABAC bin budget was exhausted, then coefficients for which the full magnitude must be signaled, are still signaled with the bypass coded dec_abs_level syntax element.

The transform coefficient magnitude can be determined by the syntax elements as follows: sig_coeff_flag+gt1_flag+gt2_flag+gt3_flag+gt4_flag+gt5_flag+gt6_flag+gt7_flag+parity_flag+2*abs_rem, or equivalently, by the mapping shown in Table 3.

TABLE 3
Proposed mapping between RRC coefficient syntax elements and coefficient magnitude

| sig_coeff | gt1 | gt2 | gt3 | gt4 | gt5 | gt6 | gt7 | Coefficient |
|---|---|---|---|---|---|---|---|---|
| flag | flag | flag | flag | flag | flag | flag | flag | magnitude |
| 0 | — | — | — | — | — | — | — | 0 |
| 1 | 0 | — | — | — | — | — | — | 1 |
| 1 | 1 | 0 | — | — | — | — | — | 2 |
| 1 | 1 | 1 | 0 | — | — | — | — | 3 |
| 1 | 1 | 1 | 1 | 0 | — | — | — | 4 |
| 1 | 1 | 1 | 1 | 1 | 0 | — | — | 5 |
| 1 | 1 | 1 | 1 | 1 | 1 | 0 | — | 6 |
| 1 | 1 | 1 | 1 | 1 | 1 | 1 | 0 | 7 |
| 1 | 1 | 1 | 1 | 1 | 1 | 1 | 1 | 8 + parity_flag + |
| | | | | | | | | 2*abs_rem |
| — | — | — | — | — | — | — | — | dec_abs_level |

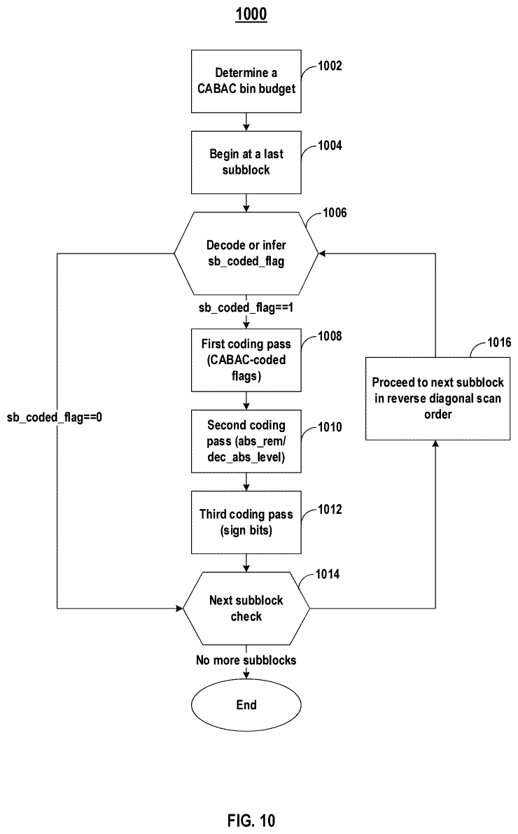

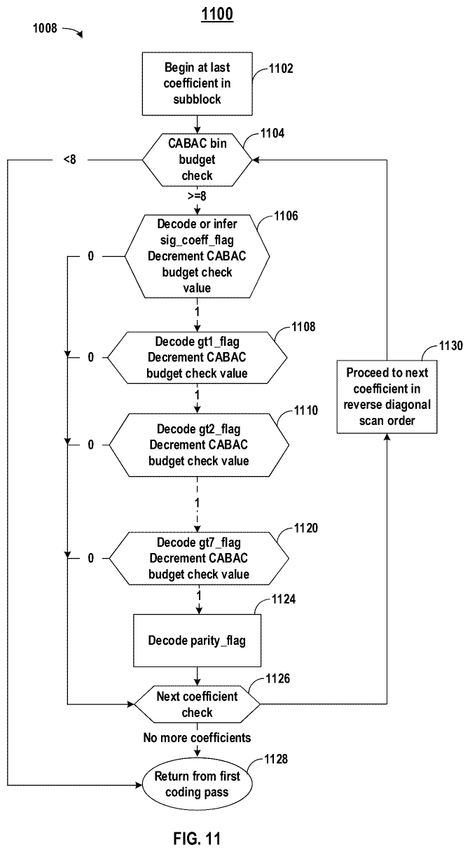

FIG. 10 illustrates a flowchart of a first method of video coding 1000, according to some embodiments of the present disclosure. FIG. 11 illustrates a flowchart of a second method of video coding 1100, according to some embodiments of the present disclosure. The second method of video coding 1100 may include operations for the first coding pass of the first method of video coding 1000. Method 1000, 1100 may be performed by a system, e.g., such as encoding system 100, decoding system 200, encoder 101, decoder 201, encoding module 320 (e.g., with a CABAC engine), or decoding module 402, just to name a few. Method 1000 may include operations 1002-1016, as described below. Method 1100 may include operations 1102-1130, as described below. FIGS. 10 and 11 will be described together.

In the first method of video coding 1000 of FIG. 10, the number of coding passes and their nature is left the same as with the RRC process in VVC. The CABAC engine determines (at 1002) the CABAC bin budget which is calculated as 1.75 bins per coefficient of the residual block. For example, if the residual block has a size of 16×8, then the CABAC bin budget is set to 1.75×16×8=224 bins. Then, beginning (at 1004) at the last residual subblock, the coding system may decode or infer (at 1006) the corresponding sb_coded_flag. A sb_coded_flag value of 1 indicates that at least one coefficient in the subblock is non-zero, while a value of 0 indicates that all the coefficients are zero. If the value of the sb_coded_flag is decoded or inferred as 0, the operations move to 1014, where the CABAC bin next subblock check is performed. Otherwise, when the value of the sb_coded_flag is 1, the operations move to a first coding pass at 1008. All CABAC-coded flags (e.g., context coded syntax elements that include the sig_coeff_flag and all the greater than X flags) are signalled in the first coding pass (at 1008). For the example described above with reference to Table 3, there are 7 greater than X flags, and so, at each coefficient up to 8 context coded flags could potentially be signalled. Additional details of the first coding pass (at 1008) are provided below in connection with FIG. 11.

Referring to FIG. 11, at 1102, operations begin at the last coefficient in the subblock. At 1104, a CABAC bin budget check is performed. In some examples, the CABAC bin budget check may be performed to determine whether there are at least 8 CABAC bins remaining. In response to at least 8 CABAC bins remaining, the operations may move to 1106; otherwise, the operations may move to 1128, and the coefficient position is recorded to a variable n.

At 1106, the value of sig_coeff_flag may be decoded or inferred, and the value of the remaining CABAC bin budget may be decremented by one bin. The sig_coeff_flag has a value of 0 when a current coefficient is zero in magnitude, and a value of 1 when the coefficient is non-zero. The sig_coeff_flag is not signalled but instead inferred to be 0 for coefficients belonging to subblocks with a coded subblock flag of 0. It may also be inferred to be 1 for other edge cases. For example, if a subblock coded flag has been set to 1 but all sig_coeff_flags within that subblock have a value of 0 until the last significant coefficient flag in the scan order of the subblock, that sig_coeff_flag must be inferred as 1. If the sig_coeff_flag is signalled (i.e. decoded), then the CABAC bin budget is decremented by one bin. If the sig_coeff_flag is 0, then the coding pass proceeds to the next coefficient (at 1126), as the current coefficient's value is already fully determined as zero. Otherwise, up to seven “greater than X” flags may be signalled (at operations 1108, 1110, . . . , 1120) being “greater than one flag” (gt1_flag), “greater than two flag” (gt2_flag), “greater than three flag” (gt3_flag), “greater than four flag” (gt4_flag), “greater than five flag” (gt5_flag), “greater than six flag” (gt6_flag), and “greater than seven flag” (gt7_flag) in signaling order. The gt1_flag is signalled first, and each subsequent greater than X flag is signalled if the prior greater than X flag had a value of 1. When any greater than X flag is signalled with a value of 0, the coding pass proceeds to the next coefficient. Otherwise, if the greater than seven flag (gt7_flag) is signalled with a value of 1, the parity flag is bypass coded (at 1124), and the coding pass proceeds to the next coefficient (at 1126). Each context coded flag that is signalled decrements the remaining CABAC bin budget by one bin, i.e. whenever a “greater than X” flag is signalled (at operations 1108, 1110, . . . , 1120) the remaining CABAC bin budget is also decremented by one bin. At 1126, if there are any further coefficients in the current subblock then the operations move (at 1130) to the next coefficient in the reverse diagonal scan order. If there are no further coefficients in the current subblock, then the operations move to 1128 and the first coding pass has completed without exhausting the CABAC bin budget, which may be recorded by setting the variable n to the value of the top-left coefficient position of the current subblock minus 1. Then, at 1128, the operations may move from the first coding pass to the second coding pass (at 1010) in FIG. 10.

Referring again to FIG. 10, the second coding pass (at 1010) is performed like the RRC process of VVC, except that in the first part of the second coding pass, abs_rem is signalled when the greater than seven flag is signalled with the value 1. The third coding pass (at 1012) is unchanged from the RRC process of VVC. Then, the next subblock check is performed (at 1014), proceeding to the next subblock (at 1016) if there are any more subblocks remaining in the reverse diagonal scan over the current residual block. If there are no more subblocks remaining in the current residual block, then the method 1000 ends.

In similar arrangements, the number of greater than X flags (F) may be modified to achieve a better trade-off between coding gain and complexity. For example, F may be 6, 8, 9, or 10. The coding passes described above are modified as follows: the CABAC bin budget check performed during the first coding pass is modified to check whether the remaining CABAC bin budget is at least (F+1) bins. For a current coefficient, the parity flag is signalled when the greater than F flag is signalled with a value of 1, and then the coding pass proceeds to the next coefficient.

An advantage of these arrangements is that the coding passes are simple. However, it results in a high threshold for the CABAC bin budget check, which can mean the potential CABAC throughput is often not utilised. This may limit the coding gain that can be achieved with the proposed RRC.

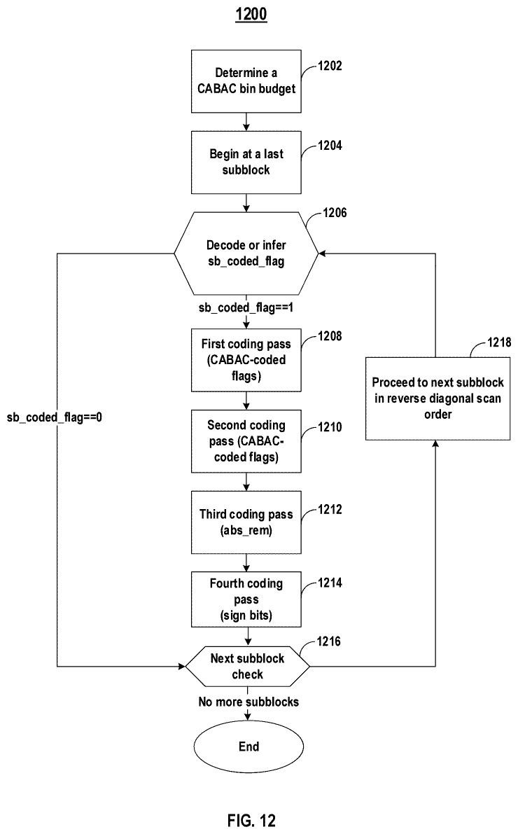

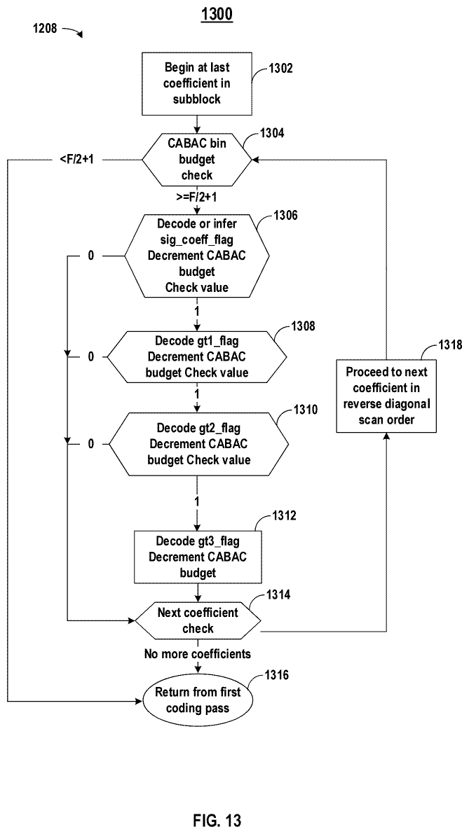

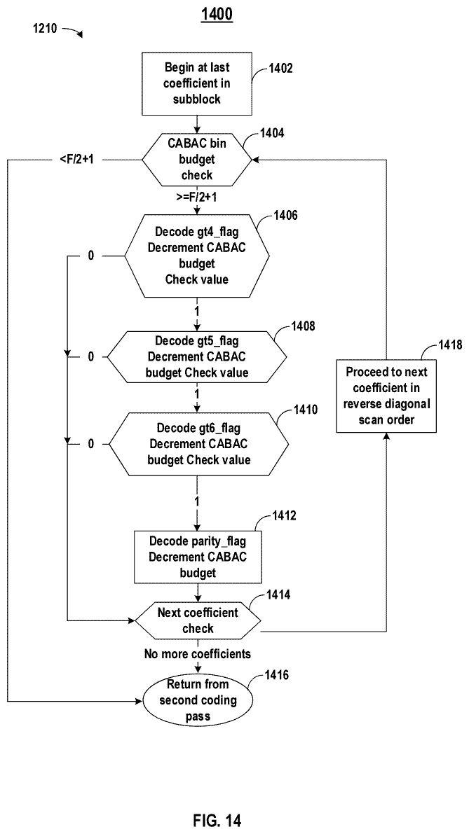

FIG. 12 illustrates a flowchart of a third method of video coding 1200, according to some embodiments of the present disclosure. FIG. 13 illustrates a flowchart of a fourth method of video coding 1300, according to some embodiments of the present disclosure. FIG. 14 illustrates a flowchart of a fifth method of video coding 1400, according to some embodiments of the present disclosure. The fourth method of video coding 1300 may include operations for the first coding pass of the third method of video coding 1200, and the fifth method of video coding 1400 may include operations for the second coding pass of the third method of video coding 1200. Method 1200, 1300, 1400 may be performed by a system, e.g., such as encoding system 100, decoding system 200, encoder 101, decoder 201, encoding module 320 (e.g., with a CABAC engine), or decoding module 402, just to name a few. Method 1200 may include operations 1202-1218, as described below. Method 1300 may include operations 1302-1218, as described below. Method 1400 may include operations 1402-1418, as described below. FIGS. 12-14 will be described together.

Referring to FIG. 12, an additional coding pass is introduced. An example is described as follows where the number of greater than X flags is set to F=6. Then, the context coded flags are signalled across two coding passes (at 1208, 1210), while the bypass coding of the coefficient magnitude remainder (abs_rem) is moved to a third coding pass (at 1212), and the signalling of sign bits is moved to a fourth coding pass (at 1214).

Referring to FIG. 13, at 1302, the operations begin at the last coefficient in the subblock. Then, at each coefficient position of the first coding pass (at 1208), the system determines (at 1304) whether the remaining CABAC bin budget is at least 4 bins. If it is less than 4 bins, then the first coding pass ends (at 1316) and the coefficient position where it has ended is recorded. Let this position be referred to as n. If the remaining CABAC bin budget is at least 4 bins, then some portion of the coefficient can be coded with context coded bins, and the operations may move to 1306.

At 1306, the sig_coeff_flag may be decoded or inferred, and the CABAC bin budget value may be decremented by 1. The sig_coeff_flag has a value of 0 when a current coefficient is zero in magnitude, and a value of 1 when the coefficient is non-zero. The sig_coeff_flag is not signalled but instead inferred to be 0 for coefficients belonging to subblocks with a coded subblock flag of 0. It may also be inferred to be 1 for other edge cases. For example, if a subblock coded flag has been set to 1 but all sig_coeff_flags within that subblock have a value of 0 until the last significant coefficient flag in the scan order of the subblock, that flag must be inferred as 1. If the sig_coeff_flag is 0, then the coding pass proceeds to the next coefficient, as the current coefficient's value is already fully determined as zero. Otherwise, up to three “greater than X” flags may be signalled, being “greater than one flag” (gt1_flag) (at 1308), “greater than two flag” (gt2_flag) (at 1310), and “greater than three flag” (gt3_flag) (at 1312) in signalling order. The gt1_flag is signalled first, and each subsequent greater than X flag is signalled if the prior greater than X flag had a value of 1. When any greater than X flag is signalled with a value of 0, the coding pass proceeds to the next coefficient (at 1314). Otherwise, if the greater than three flag is signalled with a value of 1, the coding pass still proceeds to the next coefficient (at 1314). At 1314, if there are any further coefficients in the current subblock then the operations move (at 1318) to the next coefficient in the reverse diagonal scan order. If there are no further coefficients in the current subblock, then the operations move to 1316 and the first coding pass has completed without exhausting the CABAC bin budget, which may be recorded by setting the variable n to the value of the top-left coefficient position of the current subblock minus 1.

Referring to FIG. 14, the second coding pass (at 1210) codes the remaining transform coefficient context coded flags. At each coefficient position of the second coding pass (beginning at the last coefficient of the subblock at 1402), the system may determine at (1404) whether CABAC bin budget is at least 4 bins. If it is less than 4 bins, then the second coding pass ends (at 1416) and the coefficient position where it has ended is recorded. Let this position be referred to as m. If the remaining CABAC bin budget is at least 4 bins, then some portion of the coefficient can be coded with context coded bins.

Referring to FIGS. 13 and 14, if any of the sig_coeff_flag (at 1306), gt1_flag (at 1308), gt2_flag (at 1310), or the gt3_flag (at 1312) for the current coefficient were signalled as 0 in the first coding pass, then the current coefficient's magnitude is already fully determined, and no further syntax elements need to be signalled. Then, the coding pass proceeds to the next coefficient. Otherwise, up to three further “greater than X” flags may be signalled, being “greater than four flag” (gt4_flag) (at 1406), “greater than five flag” (gt5_flag) (at 1408), and “greater than six flag” (gt6_flag) (at 1410) in signalling order. The gt4_flag is signalled first, and each subsequent greater than X flag is signalled if the prior greater than X flag had a value of 1. When any greater than X flag is signalled with a value of 0, the coding pass proceeds to the next coefficient (at 1414). Otherwise, if the greater than six flag is signalled with a value of 1, the parity flag is signalled (at 1412), and the coding pass proceeds to the next coefficient (at 1414). At 1414, if there are any further coefficients in the current subblock then the operations move (at 1418) to the next coefficient in the reverse diagonal scan order. If there are no further coefficients in the current subblock, then the operations move to 1416 and the second coding pass has completed without exhausting the CABAC bin budget, which may be recorded by setting the variable m to the value of the top-left coefficient position of the current subblock minus 1.

Referring again to FIG. 12, the third coding pass (at 1212) binarizes and codes with bypass coded bins the remaining portion of the transform coefficients that have not already been coded in the first two coding passes. The third coding pass (at 1212) is split into three parts. The first part is a pass over the coefficients from the last significant coefficient until before coefficient position m. The second part is a pass over the coefficients from position m until before coefficient position n. The third part is a pass over the coefficients from position n through to and including the top-left coefficient position. Not all the parts occur in the third coding pass. For example, if the first two coding passes completed without exhausting the CABAC bin budget, then the third coding pass will consist only of the first part. If the CABAC bin budget was exhausted in the second coding pass, then the third part of the third coding pass does not occur. If the CABAC bin budget was exhausted in the first coding pass (at 1208), it will also be exhausted before the second coding pass (at 1210) can begin, so m has a value equal to the last significant position, and the first part of the third coding pass (at 1212) does not occur.

A remainder needs to be signalled when the current coefficient's value has not already been determined by signalled flags. As show in Table 4, the coefficient can be fully determined if the sig_coeff_flag or any one of the greater than X flags has been signalled with a value of 0.

TABLE 4
Proposed mapping between RRC coefficient syntax elements and coefficient magnitude

| sig_coeff | gt1 | gt2 | gt3 | gt4 | gt5 | gt6 | Coefficient |
|---|---|---|---|---|---|---|---|
| flag | flag | flag | flag | flag | flag | flag | magnitude |
| 0 | — | — | — | — | — | — | 0 |
| 1 | 0 | — | — | — | — | — | 1 |
| 1 | 1 | 0 | — | — | — | — | 2 |
| 1 | 1 | 1 | 0 | — | — | — | 3 |
| 1 | 1 | 1 | 1 | — | — | — | 3 + abs_rem |
| 1 | 1 | 1 | 1 | 0 | — | — | 4 |
| 1 | 1 | 1 | 1 | 1 | 0 | — | 5 |
| 1 | 1 | 1 | 1 | 1 | 1 | 0 | 6 |
| 1 | 1 | 1 | 1 | 1 | 1 | 1 | 7 + parity_flag + |
| | | | | | | | 2*abs_rem |
| — | — | — | — | — | — | — | ab_rem |

Still referring to FIG. 12, for each coefficient in the first part of the third coding pass, some part of the current coefficient's magnitude has been signalled by both the first and second coding passes. In this case a remainder (abs_rem) is signalled (at 1212) when the greater than six flag has been signalled with a value of 1. Because the parity flag has been signalled, the remaining part is always even in value. Therefore, abs_rem is signalled as a non-negative integer quantity, but then multiplied by two when added to reconstruct the coefficient's magnitude. The magnitude is determined as 7+parity_flag+2*abs_rem. abs_rem is binarized with a truncated Rice-Golomb binarization and bypass coded.

For each coefficient in the second part of the third coding pass, some part of the current coefficient's magnitude has been signalled by the first coding pass, but not by the second coding pass. In this case abs_rem is signalled when the greater than three flag has been signalled with a value of 1. In this case the parity flag has not been signalled, so abs_rem cannot be multiplied by two before adding it to reconstruct the coefficient's magnitude. The magnitude is determined as 3+abs_rem. abs_rem is binarized with a truncated Rice-Golomb binarization and bypass coded.

For each coefficient in the third part of the third coding pass, the first coding pass had already terminated so all the current coefficient's value must be determined. abs_rem is not signalled and inferred as 0 for coefficients belonging to subblocks with a subblock coded flag of 0. Otherwise, it is binarized with a truncated Rice-Golomb binarization and bypass coded.

The fourth coding pass (at 1214) codes the sign bits associated with the transform coefficients. One sign bit is signalled for each non-zero transform coefficient—that is, for each coefficient with a significant coefficient flag with value 1. All the sign bits are bypass coded. Then, the next subblock check is performed (at 1216), proceeding to the next subblock (at 1218) if there are any more subblocks remaining in the reverse diagonal scan over the current residual block. If there are no more subblocks remaining in the current residual block, then the method 1200 ends.

In similar arrangements to the arrangement described with reference to Table 4, the number of greater than X flags (F) may be modified to some even integer to achieve a better trade-off between coding gain and complexity. For example, F may be 8, or 10.

Referring to FIGS. 12-14, the coding passes described above are modified according to the following. The CABAC bin budget check (at 1304, 1404) performed during the first and second coding passes (at 1208, 1210) is modified to check whether the remaining CABAC bin budget is at least (F/2+1) bins. CABAC flags from the sig_coeff_flag through to the greater than F/2 flag are signalled in the first coding pass (at 1208). CABAC flags from the greater than (F/2+1) flag through to the parity flag (e.g., parity flag is bypass coded) are signalled in the second coding pass (at 1210). The first coding pass ends with the greater than F/2 flag, so if the greater than F/2 flag is signalled with a value of 1, the coding pass proceeds to the next coefficient. The second coding pass signals further flags for the current coefficient if the greater than F/2 flag was signalled with a value of 1. If the greater than F flag is signalled with a value of 1, the parity flag is signalled, and the coding pass proceeds to the next coefficient. For each coefficient in the first part of the third coding pass (at 1212), abs_rem is signalled when the greater than F flag has been signalled with a value of 1. The coefficient's magnitude is determined as F+1+parity_flag+2*abs rem. For each coefficient in the second part of the third coding pass, abs_rem is signalled when the greater than F/2 flag has been signalled with a value of 1. The magnitude is determined as F/2+abs_rem.

Referring again to VVC, an alternative TSRC process was adopted because it was shown to provide significant coding gain for test conditions where transform skip is used extensively, e.g., coding of screen captured content. However, the TSRC process was found unsuitable for at least one other test condition where transform skip is used, e.g., namely, lossless coding of camera-captured content. As a result, disabling TSRC at the slice level was implemented in the VVC standard. It remains undesirable for a standard to have two alternative residual coding processes that must both be supported, as this raises implementation costs.

While the removal of last significant position signalling and the hierarchical forward diagonal scan order of TSRC are relatively simple to change, significant differences exist between RRC and TSRC in the different syntax elements employed in coefficient coding. TSRC uses a much larger number of greater than X flags, as well as using context coding for the sign bit.

Since the exemplary RRC process described herein also greatly expands the number of greater than X flags, it may also be suitable for coding of transform skip residuals using, e.g., sig_coeff, gt1, gt2, . . . , gt7, parity. The present disclosure provides a solution in which the proposed RRC process may be modified to also be used for a TSRC process as follows: 1) as with the TSRC in VVC, last significant position signalling is skipped, 2) subblock coding flag signalling is the same as for the TSRC in VVC, 3) a hierarchical forward diagonal scan through the residual coefficients is used instead for all the coding passes of the proposed RRC process, 4) for each of the context coded syntax elements (e.g., significant coefficient flag, greater than X flags, parity flag) separate contexts are initialised and maintained for regular transform blocks and transform skip blocks, 5) abs_rem has separate Rice parameter initialisation and updates for regular transform blocks and transform skip blocks, and 6) the same CABAC bin budget calculation is used (e.g., 1.75 bins per coefficient). The advantage of this solution is a single, flexible residual coding process that can reduce implementation costs while still providing efficient coefficient coding performance.

In VCC, the CABAC bin budget was set at 1.75 bins per coefficient to limit the maximum CABAC throughput that real-time encoders and decoders of VVC bitstreams must support. However, an improvement in compute capability will allow a higher CABAC throughput to be achieved. The solutions disclosed significantly increase the number of context coded syntax elements. Then, the CABAC bin budget may be increased, which may bring a coding benefit as a larger number of context coded syntax elements can be fully exercised. For example, in one arrangement the CABAC bin budget may be increased to 2.00 bins per coefficient. In another arrangement the CABAC bin budget may be increased to 2.25 bins per coefficient.

In some implementations, the CABAC bin budget of the TSRC process may be increased to match the CABAC bin budget of the new regular residual coding process, e.g., 2.00 bins per coefficient, 2.25 bins per coefficient, 2.5 bins per coefficient, etc. The advantage of this modification is that the TSRC process can efficiently code more syntax elements with context coding without affecting the worst-case context coding throughput requirements.

In some implementations, the CABAC bin budget may be increased for both the RRC process and the TSRC process to the same value. The value of the CABAC bin budget may be selected to trade off complexity against coding efficiency. For example, the CABAC bin budget for both the new RRC process and the TSRC process may be increased to 2.00 bins per coefficient, or 2.25 bins per coefficient.

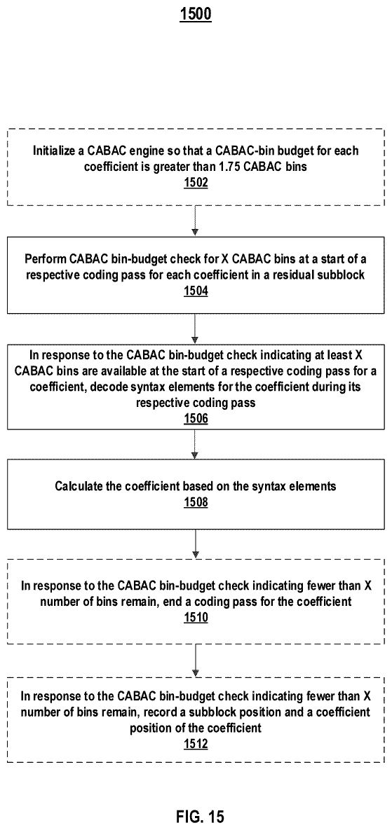

FIG. 15 illustrates a flowchart of a first exemplary method 1500 of video decoding, according to some embodiments of the present disclosure. Method 1500 may be performed by a system, e.g., such as decoding system 200, decoder 201, or decoding module 402 (e.g., with a CABAC engine), just to name a few. Method 1500 may include operations 1502-1512, as described below. It is to be appreciated that some of the steps may be optional, and some of the steps may be performed simultaneously, or in a different order than shown in FIG. 15.

Referring to FIG. 15, at 1502, the system may initialize a CABAC engine so that a CABAC-bin budget for each coefficient is greater than 1.75 CABAC bins. In some implementations, the CABAC-bin budget for each coefficient may be the same for RRC and TSRC.

At 1504, the system may perform CABAC bin-budget check for X CABAC bins at a start of a respective coding pass for each coefficient in a residual subblock. In some implementations, there may be X possible syntax elements for each coefficient. In some implementations, X may be equal to 8. In some implementations, the CABAC bin-budget check is performed as part of an RRC process. In some implementations, the CABAC bin-budget check is performed as part of a TSRC process.

At 1506, the system may, in response to the CABAC bin-budget check indicating at least X CABAC bins are available at the start of a respective coding pass for a coefficient, decode syntax elements for the coefficient during its respective coding pass. In some implementations, the 8 possible syntax elements include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

At 1508, the system may calculate the coefficient based on the syntax elements.

At 1510, the system may, in response to the CABAC bin-budget check indicating fewer than X number of bins remain, end a coding pass for the coefficient.

At 1512, the system may, in response to the CABAC bin-budget check indicating fewer than X number of bins remain, record a subblock position and a coefficient position of the coefficient.

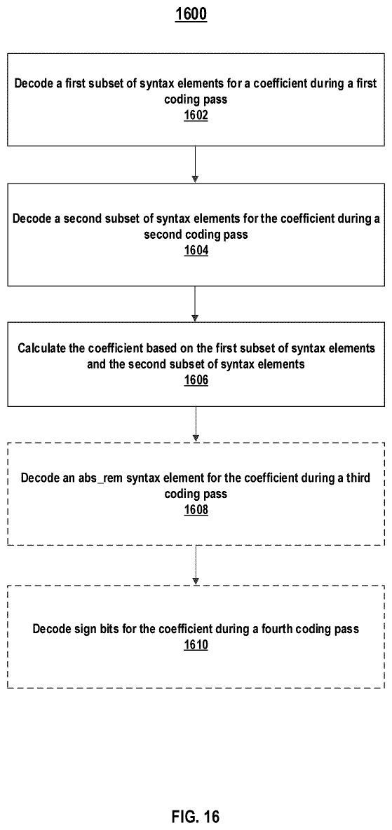

FIG. 16 illustrates a flowchart of a second exemplary method 1600 of video decoding, according to some embodiments of the present disclosure. Method 1600 may be performed by a system, e.g., such as decoding system 200, decoder 201, or decoding module 402, just to name a few. Method 1600 may include operations 1602-1610, as described below. It is to be appreciated that some of the steps may be optional, and some of the steps may be performed simultaneously, or in a different order than shown in FIG. 16.

Referring to FIG. 16, at 1602, the system may decode a first subset of syntax elements for a coefficient during a first coding pass. In some implementations, to decode the first subset of syntax element, the system may perform a first CABAC bin-budget check for X CABAC bins at a start of the first coding pass, wherein there are X possible syntax elements in the first subset of syntax elements. In some implementations, the first subset of syntax elements may be decoded in response to at least X CABAC bins being available at the start of the first coding pass.

At 1604, the system may decode a second subset of syntax elements for the coefficient during a second coding pass. In some implementations, to decode the second subset of syntax elements, the system may perform a second CABAC bin-budget check for N CABAC bins at a start of the second coding pass. In some implementations, there may be N possible syntax elements in the second subset of syntax elements. In some implementations, the second subset of syntax elements may be decoded in response to at least N CABAC bins being available at the start of the second coding pass. In some implementations, the first subset of syntax element and the second subset of syntax elements may each include the same number of syntax elements. In some implementations, the first subset of syntax element and the second subset of syntax elements may each include a different number of syntax elements.

At 1606, the system may calculate the coefficient based on the first subset of syntax elements and the second subset of syntax elements. In some implementations, the first subset of syntax elements and the second set of syntax elements may form a full set of CABAC syntax elements. In some implementations, when the abs_rem syntax element is decoded prior to a parity flag, the calculating, by the processor, the coefficient based on the first subset of syntax elements and the second subset of syntax elements may include summing, by the processor, a partial magnitude of the coefficient and a value abs_rem syntax element. In some implementations, when the abs_rem syntax element is decoded after a parity flag, the calculating, by the processor, the coefficient based on the first subset of syntax elements and the second subset of syntax elements may include summing, by the processor, a partial magnitude of the coefficient, a value of parity flag, and a value of the abs_rem syntax element multiplied by 2. In some implementations, the coefficient is calculated as part of an RRC process.

At 1608, the system may decode an abs_rem syntax element for the coefficient during a third coding pass. In some implementations, the coefficient may be further calculated based on the abs_rem syntax element.

At 1610, the system may decode sign bits for the coefficient during a fourth coding pass. In some implementations, the coefficient may be further calculated based on the sign bits.

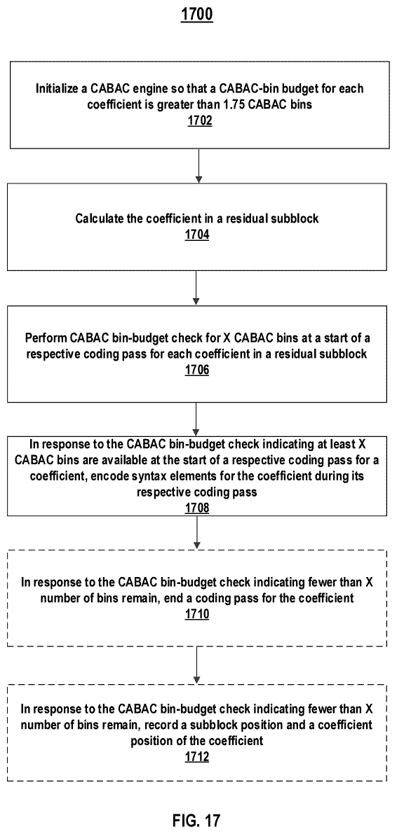

FIG. 17 illustrates a flowchart of a first exemplary method 1700 of video encoding, according to some embodiments of the present disclosure. Method 1700 may be performed by a system, e.g., such as encoding system 100, encoder 101, or encoding module 320, just to name a few. Method 1700 may include operations 1702-1712, as described below. It is to be appreciated that some of the steps may be optional, and some of the steps may be performed simultaneously, or in a different order than shown in FIG. 17.

Referring to FIG. 17, at 1702, the system may initialize a CABAC engine so that a CABAC-bin budget for each coefficient is greater than 1.75 CABAC bins. In some implementations, the CABAC-bin budget for each coefficient may be the same for RRC and TSRC.

At 1704, the system may calculate a coefficient in a residual subblock.

At 1706, the system may perform CABAC bin-budget check for X CABAC bins at a start of a respective coding pass for each coefficient in a residual subblock. In some implementations, there may be X possible syntax elements for each coefficient. In some implementations, X may be equal to 8. In some implementations, the CABAC bin-budget check is performed as part of an RRC process for the coding unit. In some implementations, the CABAC bin-budget check is performed as part of a TSRC process for the coding unit.

At 1708, the system may, in response to the CABAC bin-budget check indicating at least X CABAC bins are available at the start of a respective coding pass for a coefficient, decode syntax elements for the coefficient during its respective coding pass. In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

At 1710, the system may, in response to the CABAC bin-budget check indicating fewer than X number of bins remain, end a coding pass for the coefficient.

At 1712, the system may, in response to the CABAC bin-budget check indicating fewer than X number of bins remain, record a subblock position and a coefficient position of the coefficient.

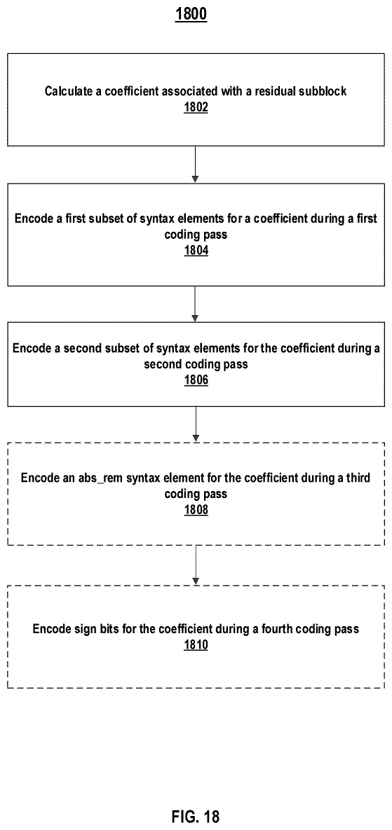

FIG. 18 illustrates a flowchart of a second exemplary method 1800 of video encoding, according to some embodiments of the present disclosure. Method 1800 may be performed by a system, e.g., such as encoding system 100, encoder 101, or encoding module 320, just to name a few. Method 1800 may include operations 1802-1810, as described below. It is to be appreciated that some of the steps may be optional, and some of the steps may be performed simultaneously, or in a different order than shown in FIG. 18.

Referring to FIG. 18, at 1802, the system may calculate a coefficient associated with a residual subblock. In some implementations, the coefficient is calculated as part of an RRC process.

At 1804, the system may encode a first subset of syntax elements for a coefficient during a first coding pass. In some implementations, to encode the first subset of syntax elements, the system may perform a first CABAC bin-budget check for X CABAC bins at a start of the first coding pass, wherein there are X possible syntax elements in the first subset of syntax elements. In some implementations, the first subset of syntax elements may be encoded in response to at least X CABAC bins being available at the start of the first coding pass.

At 1806, the system may encode a second subset of syntax elements for the coefficient during a second coding pass. In some implementations, the first subset of syntax elements and the second set of syntax elements form a full set of CABAC syntax elements. In some implementations, to encode the second subset of syntax elements, the system may perform a second CABAC bin-budget check for N CABAC bins at a start of the second coding pass, wherein there are N possible syntax elements in the second subset of syntax elements. In some implementations, the second subset of syntax elements may be encoded in response to at least N CABAC bins being available at the start of the second coding pass. In some implementations, the first subset of syntax element and the second subset of syntax elements may each include the same number of syntax elements. In some implementations, first subset of syntax element and the second subset of syntax elements may each include a different number of syntax elements.

At 1808, the system may encode an abs_rem syntax element for the coefficient during a third coding pass. In some implementations, when the abs_rem syntax element is encoded prior to a parity flag, the coefficient may be equal to a sum of a partial magnitude of the coefficient and a value abs_rem syntax element. In some implementations, when the abs_rem syntax element is encoded after a parity flag, the coefficient may be equal to a sum of a partial magnitude of the coefficient, a value of parity flag, and a value of the abs_rem syntax element multiplied by 2.

At 1810, the system may encode sign bits for the coefficient during a fourth coding pass.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding by a decoder is provided. The method may include performing, by a processor, a CABAC bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the method may include decoding, by the processor, syntax elements for the coefficient during its respective coding pass. The method may include calculating, by the processor, the coefficient based on the syntax elements.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the method may include ending, by the processor, a coding pass for the coefficient. In some implementations, in response to the CABAC bin-budget check indicating fewer than X number of bins remain, the method may include recording, by the processor, a subblock position and a coefficient position of the coefficient.

In some implementations, the CABAC bin-budget check may be performed as part of an RRC.

In some implementations, the CABAC bin-budget check may be performed as part of a TSRC.

In some implementations, the method may include initializing, by the processor, a CABAC engine so that a CABAC-bin budget for each coefficient is greater than 1.75 CABAC bins.

In some implementations, the CABAC-bin budget for each coefficient may be the same for RRC and TSRC.

According to another aspect of the present disclosure, a method of decoding by a decoder is provided. The method may include decoding, by a processor, a first subset of syntax elements for a coefficient during a first coding pass, the coefficient being associated with a residual subblock. The method may include decoding, by the processor, a second subset of syntax elements for the coefficient during a second coding pass. The method may include calculating, by the processor, the coefficient based on the first subset of syntax elements and the second subset of syntax elements. The first subset of syntax elements and the second set of syntax elements may form a full set of CABAC syntax elements.

In some implementations, the method may include decoding, by the processor, an absolute remainder (abs_rem) syntax element for the coefficient during a third coding pass. In some implementations, the coefficient may be calculated based on the abs_rem syntax element.

In some implementations, when the abs_rem syntax element is decoded prior to a parity flag, the calculating, by the processor, the coefficient based on the first subset of syntax elements and the second subset of syntax elements may include summing, by the processor, a partial magnitude of the coefficient and a value abs_rem syntax element.

In some implementations, when the abs_rem syntax element is decoded after a parity flag, the calculating, by the processor, the coefficient based on the first subset of syntax elements and the second subset of syntax elements may include summing, by the processor, a partial magnitude of the coefficient, a value of parity flag, and a value of the abs_rem syntax element multiplied by 2.

In some implementations, the method may include decoding, by the processor, sign bits for the coefficient during a fourth coding pass. In some implementations, the coefficient is further calculated based on the sign bits.

In some implementations, the coefficient may be calculated as part of an RRC process.

In some implementations, the method may include performing, by the processor, a first CABAC bin-budget check for X CABAC bins at a start of the first coding pass. In some implementations, there may be X possible syntax elements in the first subset of syntax elements. In some implementations, the method may include performing, by the processor, a second CABAC bin-budget check for N CABAC bins at a start of the second coding pass. In some implementations, there may be N possible syntax elements in the second subset of syntax elements. In some implementations, the first subset of syntax elements may be decoded in response to at least X CABAC bins being available at the start of the first coding pass. In some implementations, the second subset of syntax elements may be decoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements each include a different number of syntax elements.

According to yet another aspect of the present disclosure, a decoder is provided. The decoder may include a processor and memory storing instructions. The memory storing instructions, which when executed by the processor, may cause the processor to perform a CABAC bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the memory storing instructions, which when executed by the processor, may cause the processor to decode syntax elements for the coefficient during its respective coding pass. The memory storing instructions, which when executed by the processor, may cause the processor to calculate the coefficient based on the syntax elements.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the memory storing instructions, which when executed by the processor, may further cause the processor to end a coding pass for the coefficient. In some implementations, in response to the CABAC bin-budget check indicating fewer than X number of bins remain, the memory storing instructions, which when executed by the processor, may further cause the processor to record a subblock position and a coefficient position of the coefficient.

In some implementations, the CABAC bin-budget check may be performed as part of an RRC.

In some implementations, the CABAC bin-budget check is performed as part of a TSRC.

In some implementations, the memory storing instructions, which when executed by the processor, may cause the processor to initialize a CABAC engine so that a CABAC-bin budget for each coefficient is greater than 1.75 CABAC bins.

In some implementations, the CABAC-bin budget for each coefficient may be the same for RRC and TSRC.

According to still another aspect of the present disclosure, a decoder is provided. The decoder may include a processor and memory storing instructions. The memory storing instructions, which when executed by the processor, may cause the processor to decode a first subset of syntax elements for a coefficient during a first coding pass, the coefficient being associated with a residual subblock. The memory storing instructions, which when executed by the processor, may cause the processor to decode a second subset of syntax elements for the coefficient during a second coding pass. The memory storing instructions, which when executed by the processor, may cause the processor to calculate the coefficient based on the first subset of syntax elements and the second subset of syntax elements. The first subset of syntax elements and the second set of syntax elements form a full set of CABAC syntax elements.

In some implementations, the memory storing instructions, which when executed by the processor, may cause the processor to decode an abs_rem syntax element for the coefficient during a third coding pass. In some implementations, the coefficient is further calculated based on the abs_rem syntax element.

In some implementations, when the abs_rem syntax element is decoded prior to a parity flag, to calculate the coefficient based on the first subset of syntax elements and the second subset of syntax elements, the memory storing instructions, which when executed by the processor, may cause the processor to sum a partial magnitude of the coefficient and a value abs_rem syntax element.

In some implementations, when the abs_rem syntax element is decoded after a parity flag, to calculate the coefficient based on the first subset of syntax elements and the second subset of syntax elements, the memory storing instructions, which when executed by the processor, may cause the processor to sum a partial magnitude of the coefficient, a value of parity flag, and a value of the abs_rem syntax element multiplied by 2.

In some implementations, the memory storing instructions, which when executed by the processor, may cause the processor to decode, sign bits for the coefficient during a fourth coding pass. In some implementations, the coefficient may be further calculated based on the sign bits.

In some implementations, the coefficient may be calculated as part of an RRC process.

In some implementations, the memory storing instructions, which when executed by the processor, may cause the processor to perform a first CABAC bin-budget check for X CABAC bins at a start of the first coding pass. In some implementations, there may be X possible syntax elements in the first subset of syntax elements. In some implementations, the memory storing instructions, which when executed by the processor, may cause the processor to perform a second CABAC bin-budget check for N CABAC bins at a start of the second coding pass. In some implementations, there may be N possible syntax elements in the second subset of syntax elements. In some implementations, the first subset of syntax elements may be decoded in response to at least X CABAC bins being available at the start of the first coding pass. In some implementations, the second subset of syntax elements may be decoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements may each include a different number of syntax elements.

According to still a further aspect of the present disclosure, an apparatus for decoding is provided. The apparatus for decoding may include a processor and memory storing instructions. The memory storing instructions, which when executed by the processor, may cause the processor to perform a CABAC bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the memory storing instructions, which when executed by the processor, may cause the processor to decode syntax elements for the coefficient during its respective coding pass. The memory storing instructions, which when executed by the processor, may cause the processor to calculate the coefficient based on the syntax elements.

According to yet a further aspect of the present disclosure, an apparatus for decoding is provided. The apparatus for decoding may include a processor and memory storing instructions. The memory storing instructions, which when executed by the processor, may cause the processor to decode a first subset of syntax elements for a coefficient during a first coding pass, the coefficient being associated with a residual subblock. The memory storing instructions, which when executed by the processor, may cause the processor to decode a second subset of syntax elements for the coefficient during a second coding pass. The memory storing instructions, which when executed by the processor, may cause the processor to calculate the coefficient based on the first subset of syntax elements and the second subset of syntax elements. The first subset of syntax elements and the second set of syntax elements form a full set of CABAC syntax elements.

According to yet another aspect of the present disclosure, a non-transitory computer-readable medium storing instructions is provided. The instructions, which when executed by a processor of a decoder, may cause the processor of the decoder to perform a CABAC bin-budget check for X CABAC bins at a start of a respective coding pass for each coefficient in a residual subblock. There may be X possible syntax elements for each coefficient. In response to the CABAC bin-budget check indicating at least X CABAC bins are available at the start of a respective coding pass for a coefficient, the instructions, which when executed by a processor of a decoder, may cause the processor of the decoder to decode syntax elements for the coefficient during its respective coding pass. The instructions, which when executed by a processor of a decoder, may cause the processor of the decoder to calculate the coefficient based on the syntax elements.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the instructions, which when executed by the processor of the decoder, may further cause the processor of the decoder to end a coding pass for the coefficient. In some implementations, in response to the CABAC bin-budget check indicating fewer than X number of bins remain, the instructions, which when executed by the processor of the decoder, may further cause the processor of the decoder to record a subblock position and a coefficient position of the coefficient.

In some implementations, the CABAC bin-budget check may be performed as part of an RRC.

In some implementations, the CABAC bin-budget check is performed as part of a TSRC.

In some implementations, the instructions, which when executed by the processor of the decoder, may cause the processor of the decoder to initialize a CABAC engine so that a CABAC-bin budget for each coefficient is greater than 1.75 CABAC bins.

In some implementations, the CABAC-bin budget for each coefficient may be the same for RRC and TSRC.

According to still a further aspect of the present disclosure, a non-transitory computer-readable medium storing instructions is provided. The instructions, which when executed by a processor of a decoder, cause the processor of the decoder to decode a first subset of syntax elements for a coefficient during a first coding pass, the coefficient being associated with a residual subblock. The instructions, which when executed by a processor of a decoder, cause the processor of the decoder to decode a second subset of syntax elements for the coefficient during a second coding pass. The instructions, which when executed by a processor of a decoder, cause the processor of the decoder to calculate the coefficient based on the first subset of syntax elements and the second subset of syntax elements. The first subset of syntax elements and the second set of syntax elements form a full set of CABAC syntax elements.

In some implementations, the instructions, which when executed by the processor of the decoder, may cause the processor of the decoder to decode an abs_rem syntax element for the coefficient during a third coding pass. In some implementations, the coefficient may be further calculated based on the abs_rem syntax element.

In some implementations, when the abs_rem syntax element is decoded prior to a parity flag, to calculate the coefficient based on the first subset of syntax elements and the second subset of syntax elements, the instructions, which when executed by the processor of the decoder, may cause the processor of the decoder to sum a partial magnitude of the coefficient and a value abs_rem syntax element.

In some implementations, when the abs_rem syntax element is decoded after a parity flag, to calculate the coefficient based on the first subset of syntax elements and the second subset of syntax elements, the instructions, which when executed by the processor of the decoder, may cause the processor of the decoder to sum a partial magnitude of the coefficient, a value of parity flag, and a value of the abs_rem syntax element multiplied by 2.

In some implementations, the instructions, which when executed by the processor of the decoder, may cause the processor of the decoder to decode, sign bits for the coefficient during a fourth coding pass. In some implementations, the coefficient may be further calculated based on the sign bits.

In some implementations, the coefficient is calculated as part of an RRC process.

In some implementations, the instructions, which when executed by the processor of the decoder, may cause the processor of the decoder to perform a first CABAC bin-budget check for X CABAC bins at a start of the first coding pass. In some implementations, there may be X possible syntax elements in the first subset of syntax elements. In some implementations, the instructions, which when executed by the processor of the decoder, may cause the processor of the decoder to perform a second CABAC bin-budget check for N CABAC bins at a start of the second coding pass. In some implementations, there are N possible syntax elements in the second subset of syntax elements. In some implementations, the first subset of syntax elements may be decoded in response to at least X CABAC bins being available at the start of the first coding pass. In some implementations, the second subset of syntax elements may be decoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements each include a different number of syntax elements.

According to still a further aspect of the present disclosure, a method of encoding by An encoder is provided. The method may include calculating, by a processor, a coefficient in a residual subblock. The method may include performing, by a processor, a CABAC bin-budget check for X CABAC bins at a start of a respective coding pass for each coefficient in the residual subblock. There may be X possible syntax elements for each coefficient. In response to the CABAC bin-budget check indicating at least X CABAC bins are available at the start of a respective coding pass for a coefficient, the method may include encoding, by the processor, syntax elements for the coefficient during its respective coding pass.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the method may further include ending, by the processor, a coding pass for the coefficient. In some implementations, in response to the CABAC bin-budget check indicating fewer than X number of bins remain, the method may further include recording, by the processor, a subblock position and a coefficient position of the coefficient.

In some implementations, the CABAC bin-budget check may be performed as part of an RRC.

In some implementations, the CABAC bin-budget check may be performed as part of a TSRC.

In some implementations, the method may further include initializing, by the processor, a CABAC engine so that a CABAC-bin budget for each coefficient is greater than 1.75 CABAC bins.

In some implementations, the CABAC-bin budget for each coefficient may be the same for RRC and TSRC.

According to still another aspect of the present disclosure, a method of encoding is provided. The method may include calculating, by the processor, a coefficient associated with a residual subblock. The method may include encoding, by a processor, a first subset of syntax elements for a coefficient during a first coding pass. The method may include encoding, by the processor, a second subset of syntax elements for the coefficient during a second coding pass. The first subset of syntax elements and the second set of syntax elements may form a full set of CABAC syntax elements.

In some implementations, the method may include encoding, by the processor, an abs_rem syntax element for the coefficient during a third coding pass. In some implementations, the coefficient may be further calculated based on the abs_rem syntax element.

In some implementations, when the abs_rem syntax element is encoded prior to a parity flag, the coefficient may be equal to a sum of a partial magnitude of the coefficient and a value abs_rem syntax element.

In some implementations, when the abs_rem syntax element is encoded after a parity flag, the coefficient may be equal to a sum of a partial magnitude of the coefficient, a value of parity flag, and a value of the abs_rem syntax element multiplied by 2.

In some implementations, the method may include encoding, by the processor, sign bits for the coefficient during a fourth coding pass. In some implementations, the coefficient may be further calculated based on the sign bits.

In some implementations, the coefficient may be calculated as part of an RRC process.

In some implementations, the method may include performing, by the processor, a first CABAC bin-budget check for X CABAC bins at a start of the first coding pass. In some implementations, there are X possible syntax elements in the first subset of syntax elements. In some implementations, the method may include performing, by the processor, a second CABAC bin-budget check for N CABAC bins at a start of the second coding pass. In some implementations, there may be N possible syntax elements in the second subset of syntax elements. In some implementations, the first subset of syntax elements may be encoded in response to at least X CABAC bins being available at the start of the first coding pass. In some implementations, the second subset of syntax elements may be encoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements may each include a different number of syntax elements.

According to yet a further aspect of the present disclosure, an encoder is provided. The encoder may include a processor and memory storing instructions. The memory storing instructions, which when executed by the processor, may cause the processor to calculate a coefficient in a residual subblock. The memory storing instructions, which when executed by the processor, may cause the processor to perform a CABAC bin-budget check for X CABAC bins at a start of a respective coding pass for each coefficient in the residual subblock. There may be X possible syntax elements for each coefficient. In response to the CABAC bin-budget check indicating at least X CABAC bins are available at the start of a respective coding pass for a coefficient, the memory storing instructions, which when executed by the processor, may cause the processor to encode syntax elements for the coefficient during its respective coding pass.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the memory storing instructions, which when executed by the processor, may further cause the processor to end a coding pass for the coefficient. In some implementations, in response to the CABAC bin-budget check indicating fewer than X number of bins remain, the memory storing instructions, which when executed by the processor, may further cause the processor to record a subblock position and a coefficient position of the coefficient.

In some implementations, the CABAC bin-budget check may be performed as part of an RRC.

In some implementations, the CABAC bin-budget check is performed as part of a TSRC.

In some implementations, the memory storing instructions, which when executed by the processor, may cause the processor to initialize a CABAC engine so that a CABAC-bin budget for each coefficient is greater than 1.75 CABAC bins.

In some implementations, the CABAC-bin budget for each coefficient may be the same for RRC and TSRC.

According to still another aspect of the present disclosure, an encoder is provided. The encoder may include a processor and memory storing instructions. The memory storing instructions, which when executed by the processor, may cause the processor to calculate a coefficient associated with a residual subblock. The memory storing instructions, which when executed by the processor, may cause the processor to encode a first subset of syntax elements for a coefficient during a first coding pass. The memory storing instructions, which when executed by the processor, may cause the processor to encode a second subset of syntax elements for the coefficient during a second coding pass. The first subset of syntax elements and the second set of syntax elements form a full set of CABAC syntax elements.

In some implementations, the memory storing instructions, which when executed by the processor, may cause the processor to encode an abs_rem syntax element for the coefficient during a third coding pass. In some implementations, the coefficient may be further calculated based on the abs_rem syntax element.

In some implementations, when the abs_rem syntax element is encoded prior to a parity flag, the coefficient may be equal to a sum of a partial magnitude of the coefficient and a value abs_rem syntax element.

In some implementations, when the abs_rem syntax element is encoded after a parity flag, the coefficient may be equal to a sum of a partial magnitude of the coefficient, a value of parity flag, and a value of the abs_rem syntax element multiplied by 2.

In some implementations, the memory storing instructions, which when executed by the processor, may cause the processor to encode, sign bits for the coefficient during a fourth coding pass. In some implementations, the coefficient may be further calculated based on the sign bits.

In some implementations, the coefficient may be calculated as part of an RRC process.

In some implementations, the memory storing instructions, which when executed by the processor, may cause the processor to perform a first CABAC bin-budget check for X CABAC bins at a start of the first coding pass. In some implementations, there may be X possible syntax elements in the first subset of syntax elements. In some implementations, the memory storing instructions, which when executed by the processor, may cause the processor to perform a second CABAC bin-budget check for N CABAC bins at a start of the second coding pass. In some implementations, there may be N possible syntax elements in the second subset of syntax elements. In some implementations, the first subset of syntax elements may be encoded in response to at least X CABAC bins being available at the start of the first coding pass. In some implementations, the second subset of syntax elements may be encoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements may each include a different number of syntax elements.

According to yet another aspect of the present disclosure, an apparatus for encoding is provided. The apparatus for encoding may include a processor and memory storing instructions. The memory storing instructions, which when executed by the processor, may cause the processor to calculate a coefficient in a residual subblock. The memory storing instructions, which when executed by the processor, may cause the processor to perform a CABAC bin-budget check for X CABAC bins at a start of a respective coding pass for each coefficient in the residual subblock. There may be X possible syntax elements for each coefficient. In response to the CABAC bin-budget check indicating at least X CABAC bins are available at the start of a respective coding pass for a coefficient, the memory storing instructions, which when executed by the processor, may cause the processor to encode syntax elements for the coefficient during its respective coding pass.

According to still a further aspect of the present disclosure, an apparatus for encoding is provided. The apparatus for encoding may include a processor and memory storing instructions. The memory storing instructions, which when executed by the processor, may cause the processor to calculate a coefficient associated with a residual subblock. The memory storing instructions, which when executed by the processor, may cause the processor to encode a first subset of syntax elements for a coefficient during a first coding pass. The memory storing instructions, which when executed by the processor, may cause the processor to encode a second subset of syntax elements for the coefficient during a second coding pass. The first subset of syntax elements and the second set of syntax elements form a full set of CABAC syntax elements.

According to still a further aspect of the present disclosure, a non-transitory computer-readable medium storing instructions for an encoder is provided. The instructions, which when executed by the processor of the encoder, may cause the processor of the encoder to calculate a coefficient in a residual subblock. The instructions, which when executed by the processor of the encoder, may cause the processor of the encoder to perform a CABAC bin-budget check for X CABAC bins at a start of a respective coding pass for each coefficient in the residual subblock. There may be X possible syntax elements for each coefficient. In response to the CABAC bin-budget check indicating at least X CABAC bins are available at the start of a respective coding pass for a coefficient, the instructions, which when executed by the processor of the encoder, may cause the processor of the encoder to encode syntax elements for the coefficient during its respective coding pass.

In some implementations, X may be equal to 8.

In some implementations, the 8 possible syntax elements may include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

In some implementations, in response to the CABAC bin-budget check indicating fewer than X number of bins remain, the instructions, which when executed by the processor, may further cause the processor to end a coding pass for the coefficient. In some implementations, in response to the CABAC bin-budget check indicating fewer than X number of bins remain, the instructions, which when executed by the processor, may further cause the processor to record a subblock position and a coefficient position of the coefficient.

In some implementations, the CABAC bin-budget check may be performed as part of an RRC.

In some implementations, the CABAC bin-budget check is performed as part of a TSRC.

In some implementations, the instructions, which when executed by the processor of the encoder, may cause the processor of the encoder to initialize a CABAC engine so that a CABAC-bin budget for each coefficient is greater than 1.75 CABAC bins.

In some implementations, the CABAC-bin budget for each coefficient may be the same for RRC and TSRC.

According to still a further aspect of the present disclosure, a non-transitory computer-readable medium storing instructions for an encoder is provided. The instructions, which when executed by the processor of the encoder, may cause the processor of the encoder to calculate a coefficient associated with a residual subblock. The instructions, which when executed by the processor of the encoder, may cause the processor of the encoder to encode a first subset of syntax elements for a coefficient during a first coding pass. The instructions, which when executed by the processor of the encoder, may cause the processor of the encoder to encode a second subset of syntax elements for the coefficient during a second coding pass. The first subset of syntax elements and the second set of syntax elements form a full set of CABAC syntax elements.

In some implementations, the instructions, which when executed by the processor of the encoder, may cause the processor of the encoder to encode an abs_rem syntax element for the coefficient during a third coding pass. In some implementations, the coefficient may be further calculated based on the abs_rem syntax element.

In some implementations, when the abs_rem syntax element is encoded prior to a parity flag, the coefficient may be equal to a sum of a partial magnitude of the coefficient and a value abs_rem syntax element.

In some implementations, when the abs_rem syntax element is encoded after a parity flag, the coefficient may be equal to a sum of a partial magnitude of the coefficient, a value of parity flag, and a value of the abs_rem syntax element multiplied by 2.

In some implementations, the instructions, which when executed by the processor of the encoder, may cause the processor of the encoder to encode, sign bits for the coefficient during a fourth coding pass. In some implementations, the coefficient may be further calculated based on the sign bits.

In some implementations, the coefficient may be calculated as part of an RRC process.

In some implementations, the instructions, which when executed by the processor of the encoder, may cause the processor of the encoder to perform a first CABAC bin-budget check for X CABAC bins at a start of the first coding pass. In some implementations, there may be X possible syntax elements in the first subset of syntax elements. In some implementations, the instructions, which when executed by the processor of the encoder, may cause the processor of the encoder to perform a second CABAC bin-budget check for N CABAC bins at a start of the second coding pass. In some implementations, there may be N possible syntax elements in the second subset of syntax elements. In some implementations, the first subset of syntax elements may be encoded in response to at least X CABAC bins being available at the start of the first coding pass. In some implementations, the second subset of syntax elements may be encoded in response to at least N CABAC bins being available at the start of the second coding pass.

In some implementations, the first subset of syntax element and the second subset of syntax elements may each include a same number of syntax elements. In some implementations, the first subset of syntax element and the second subset of syntax elements may each include a different number of syntax elements.

According to still another aspect of the present disclosure, a non-transitory computer-readable medium storing a bitstream is provided. The bitstream may be generated according to one or more of the operations described herein.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
performing, by a processor, a context-adaptive binary arithmetic coding (CABAC) bin-budget check for X CABAC bins at a start of a respective coding pass for each coefficient in a residual subblock, wherein there are X possible syntax elements for each coefficient;
in response to the CABAC bin-budget check indicating at least X CABAC bins are available at a start of a respective coding pass for a coefficient, decoding, by the processor, syntax elements for the coefficient during its respective coding pass; and
calculating, by the processor, the coefficient based on the syntax elements.

2. The method of claim 1, wherein X is equal to 8.

3. The method of claim 2, wherein the 8 possible syntax elements include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

4. The method of claim 1, wherein, in response to the CABAC bin-budget check indicating fewer than X number of bins remain, the method further comprises:
ending, by the processor, a coding pass for the coefficient; and
recording, by the processor, a subblock position and a coefficient position of the coefficient.

5. The method of claim 1, wherein the CABAC bin-budget check is performed as part of a regular residual coding (RRC).

6. The method of claim 1, wherein the CABAC bin-budget check is performed as part of a transform-skip residual coding (TSRC).

7. The method of claim 1, further comprising:
initializing, by the processor, a CABAC engine so that a CABAC-bin budget for each coefficient is greater than 1.75 CABAC bins.

8. The method of claim 7, wherein the CABAC-bin budget for each coefficient is the same for regular residual coding (RRC) and transform-skip residual coding (TSRC).

9. A decoder, comprising:
a processor; and
a memory storing instructions, which when executed by the processor, cause the processor to:
perform a context-adaptive binary arithmetic coding (CABAC) bin-budget check for X CABAC bins at a start of a respective coding pass for each coefficient in a residual subblock, wherein there are X possible syntax elements for each coefficient;
in response to the CABAC bin-budget check indicating at least X CABAC bins are available at the start of a respective coding pass for a coefficient, decode syntax elements for the coefficient during its respective coding pass; and
calculate the coefficient based on the syntax elements.

10. The decoder of claim 9, wherein X is equal to 8.

11. The decoder of claim 10, wherein the 8 possible syntax elements include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

12. A method of encoding by an encoder, comprising:
calculating, by a processor, a coefficient in a residual subblock;
performing, by the processor, a context-adaptive binary arithmetic coding (CABAC) bin-budget check for X CABAC bins at a start of a respective coding pass for each coefficient in the residual subblock, wherein there are X possible syntax elements for each coefficient; and
in response to the CABAC bin-budget check indicating at least X CABAC bins are available at the start of a respective coding pass for a coefficient, encoding, by the processor, syntax elements for the coefficient during its respective coding pass.

13. The method of claim 12, wherein X is equal to 8.

14. The method of claim 13, wherein the 8 possible syntax elements include a significant coefficient (sig_coeff) flag, a greater-than-1 (gt1) flag, a greater-than-2 (gt2) flag, a greater-than-3 (gt3) flag, a greater-than-4 (gt4) flag, a greater-than-5 (gt5) flag, a greater-than-6 (gt6) flag, and a greater-than-7 (gt7) flag.

15. The method of claim 12, wherein, in response to the CABAC bin-budget check indicating fewer than X number of bins remain, the method further comprises:
ending, by the processor, a coding pass for the coefficient; and
recording, by the processor, a subblock position and a coefficient position of the coefficient.

16. The method of claim 12, wherein the CABAC bin-budget check is performed as part of a regular residual coding (RRC).

17. The method of claim 12, wherein the CABAC bin-budget check is performed as part of a transform-skip residual coding (TSRC).

18. The method of claim 12, further comprising:
initializing, by the processor, a CABAC engine so that a CABAC-bin budget for each coefficient is greater than 1.75 CABAC bins.

19. The method of claim 18, wherein the CABAC-bin budget for each coefficient is the same for regular residual coding (RRC) and transform-skip residual coding (TSRC).

20. A non-transitory computer-readable medium storing a computer program and a bitstream, wherein when the computer program is executed by a processor, the computer program causes the processor to generate the bitstream according to the method of claim 12.
